(19) United States
(12) Patent Application Publication
(10) Pub. No.: US 2008/0086274 A1
(43) Pub. Date: Apr. 10, 2008

(54) Method and Apparatus for Protein Sequence Alignment Using FPGA Devices

(76) Inventors: Roger Dean Chamberlain, St. Louis, MO (US); Jeremy Daniel Buhler, Clayton, MO (US); Arpith Chacko Jacob, St. Louis, MO (US); Joseph Marion Lancaster, St. Louis, MO (US); Brandon Baxter Harris, Oakland, CA (US)

Correspondence Address: THOMPSON COBURN LLP;ATTN: RICHARD E. HAFERKAMP, ONE U.S. BANK PLAZA, SAINT LOUIS, MO, 63101, US

(21) Appl. No.: 11/836,947

(22) Filed: Aug. 10, 2007

Related U.S. Application Data
(60) Provisional application No. 60/836,813, filed on Aug. 10, 2006.

(51) Int. Cl. G06F 19/00

(52) U.S. Cl. 702/19

(57) ABSTRACT

Disclosed herein is a hardware implementation for performing sequence alignment that preferably deploys a seed generation stage, an ungapped extension stage, and at least a portion of a gapped extension stage as a data processing pipeline on at least one hardware logic device. Hardware circuits for the seed generation stage, the ungapped extension stage, and the gapped extension stage are individually disclosed. In a preferred embodiment, the pipeline is arranged for performing BLASTP sequence alignment searching. Also, in a preferred embodiment, the at least one hardware logic device comprises at least one reconfigurable logic device such as an FPGA.

### CROSS-REFERENCE TO AND PRIORITY CLAIM TO RELATED PATENT APPLICATIONS

This application claims priority to U.S. provisional patent application 60/836,813, filed Aug. 10, 2006, entitled “Method and Apparatus for Protein Sequence Alignment Using FPGA Devices”, the entire disclosure of which is incorporated herein by reference.

This application is related to pending U.S. patent application Ser. No. 11/359,285 filed Feb. 22, 2006, entitled “Method and Apparatus for Performing Biosequence Similarity Searching” and published as U.S. Patent Application Publication 2007/0067108, which claims the benefit of both U.S. Provisional Application No. 60/658,418, filed on Mar. 3, 2005 and U.S. Provisional Application No. 60/736,081, filed on Nov. 11, 2005, the entire disclosures of each of which are incorporated herein by reference.

### FIELD OF THE INVENTION

The present invention relates to the field of sequence similarity searching. In particular, the present invention relates to the field of searching large databases of protein biological sequences for strings that are similar to a query sequence.

### BACKGROUND AND SUMMARY OF THE INVENTION

Sequence analysis is a commonly used tool in computational biology to help study the evolutionary relationship between two sequences, by attempting to detect patterns of conservation and divergence. Sequence analysis measures the similarity of two sequences by performing inexact matching, using biologically meaningful mutation probabilities. As used herein, the term “sequence” refers to an ordered list of items, wherein each item is represented by a plurality of adjacent bit values. The items can be symbols from a finite symbol alphabet. In computational biology, the symbols can be DNA bases, protein residues, etc. As an example, each symbol that represents an amino acid may be represented by 5 adjacent bit values. A high-scoring alignment of the two sequences matches as many identical residues as possible while keeping differences to a minimum, thus recreating a hypothesized chain of mutational events that separates the two sequences.

Biologists use high-scoring alignments as evidence in deducing homology, i.e., that the two sequences share a common ancestor. Homology between sequences implies a possible similarity in function or structure, and information known for one sequence can be applied to the other. Sequence analysis helps to quickly understand an unidentified sequence using existing information. Considerable effort has been spent in collecting and organizing information on existing sequences. An unknown DNA or protein sequence, termed the query sequence, can be compared to a database of annotated sequences such as GenBank or Swiss-Prot to detect homologs.

Sequence databases continue to grow exponentially as entire genomes of organisms are sequenced, making sequence analysis a computationally demanding task. For example, since its release in 1982, the GenBank DNA database has doubled in size approximately every 18 months. The International Nucleotide Sequence Databases comprised of DNA and RNA sequences from GenBank, the European Molecular Biology Laboratory's European Bioinformatics Institute (EMBL-Bank), and the DNA Data Bank of Japan recently announced a significant milestone in archiving 100 gigabases of sequence data. The Swiss-Prot protein database has experienced a corresponding growth as newly sequenced genomic DNA are translated into proteins. Existing sequence analysis tools are fast becoming outdated in the post-genomic era.

The most widely used software for efficiently comparing biosequences to a database is known as BLAST (the Basic Local Alignment Search Tool). BLAST compares a query sequence to a database sequence to find sequences in the database that exactly match the query sequence (or a subportion thereof) or differ from the query sequence (or a subportion thereof) by a small number of “edits” (which may be single-character insertions, deletions or substitutions). Because direct measurement of edit distance between sequences is computationally expensive, BLAST uses a variety of heuristics to identify small portions of a large database that are worth comparing carefully to the query sequence.

In an effort to meet a need in the art for BLAST acceleration, particularly BLASTP acceleration, the inventors herein disclose the following.

According to one aspect of a preferred embodiment of the present invention, the inventors disclose a BLAST design wherein all three stages of BLAST are implemented in hardware as a data processing pipeline. Preferably, this pipeline implements three stages of BLASTP, wherein the first stage comprises a seed generation stage, the second stage comprises an ungapped extension analysis stage, and wherein the third stage comprises a gapped extension analysis stage. However, it should be noted that only a portion of the gapped extension stage may be implemented in hardware, such as a prefilter portion of the gapped extension stage as described herein. It is also preferred that the hardware logic device (or devices) on which the pipeline is deployed be a reconfigurable logic device (or devices). A preferred example of such a reconfigurable logic device is a field programmable gate array (FPGA).

According to another aspect of a preferred embodiment of the present invention, the inventors herein disclose a design for deploying the seed generation stage of BLAST, particularly BLASTP, in hardware (preferably in reconfigurable logic such as an FPGA). Two components of the seed generation stage comprise a word matching module and a hit filtering module.

As one aspect of this design for the word matching module of the seed generation stage, disclosed herein is a hit generator that uses a lookup table to find hits between a plurality of database w-mers and a plurality of query w-mers. Preferably, this lookup table includes addresses corresponding to all possible w-mers that may be present in the database sequence. Stored at each address is preferably a position identifier for each query w-mer that is deemed a match to a database w-mer whose residues are the same as those of the lookup table address. A position identifier in the lookup table preferably identifies the position in the query sequence for the “matching” query w-mer.

Given that a query w-mer may (and likely will) exist at multiple positions within the query sequence, multiple position identifiers may (and likely will) map to the same lookup table address. To accommodate situations where the number of position identifiers for a given address exceeds the storage space available for that address (e.g., 32 bits), the lookup table preferably comprises two subtables—a primary table and a duplicate table. If the storage space for addresses in the lookup table corresponds to a maximum of Z position identifiers for each address, the primary table will store position identifiers for matching query w-mers when the number of such position identifiers is less than or equal to Z. If the number of such position identifiers exceeds Z, then the duplicate table will be used to store the position identifiers, and the address of the primary table corresponding to that matching query w-mer will be populated with data that identifies where in the duplicate table all of the pertinent position identifiers can be found.

In one embodiment, this lookup table is stored in memory that is offchip from the reconfigurable logic device. Thus, accessing the lookup table to find hits is a potential bottleneck source for the pipelined processing of the seed generation stage. Therefore, it is desirable to minimize the need to perform multiple lookups in the lookup table when retrieving the position identifiers corresponding to hits between the database w-mers and the query w-mers, particularly lookups in the duplicate table. As one solution to this problem, the inventors herein disclose a preferred embodiment wherein the position identifiers are modular delta encoded into the lookup table addresses. Consider an example where the query sequence is of residue length 2048 (or 2¹¹). If the w-mer length, w, were to be 3, this means that the number of query positions (qᵢ) for the query w-mers would be 2046 (or q=1:2046). Thus, to represent q without encoding, 11 bits would be needed. Furthermore, in such a situation, each lookup table address would need at least Z*11 bits (plus one additional bit for flagging whether reference to the duplicate table is needed) of space to store the limit of Z position identifiers. If z were equal to 3, this translates to a need for 34 bits. However, most memory devices such as SRAM are 32 bits or 64 bits wide. If a practitioner of the present invention were to use a 32 bit wide SRAM device to store the lookup table, there would not be sufficient room in the SRAM addresses for storing Z position identifiers. However, by modular delta encoding each position identifier, this aspect of the preferred embodiment of the present invention allows for Z position identifiers to be stored in a single address of the lookup table. This efficient storage technique enhances the throughput of the seed generation pipeline because fewer lookups into the duplicate table will need to be performed. The modular delta encoding of position identifiers can be performed in software as part of a query pre-processing operation, with the results of the modular delta encoding to be stored in the SRAM at compile time.

As another aspect of the preferred embodiment, optimal base selection can also be used to reduce the memory capacity needed to implement the lookup table. Continuing with the example above (where the query sequence length is 2048 and the w-mer length w is 3), it should be noted that the protein residues of the protein biosequence are preferably represented by a 20 residue alphabet. Thus, to represent a given residue, the number of bits needed would be 5 (wherein 2⁵=32; which provides sufficient granularity for representing a 20 residue alphabet). Without optimal base selection, the number of bit values needed to represent every possible combination of residues in the w-mers would be 2^{5w} (or 32,768 when w equals 3), wherein these bit values would serve as the addresses of the lookup table. However, given the 20 residue alphabet, only 20^{w} (or 8,000 when w equals 3) of these addresses would specify a valid w-mer. To solve this potential problem of wasted memory space, the inventors herein disclose an optimal base selection technique based on polynomial evaluation techniques for restricting the lookup table addresses to only valid w-mers. Thus, with this aspect of the preferred design, the key used for lookups into the lookup table uses a base equal to the size of the alphabet of interest, thereby allowing an efficient use of memory resources.

According to another aspect of the preferred embodiment, disclosed herein is a hit filtering module for the seed generation stage. Given the high volume of hits produced as a result of lookups in the lookup table, and given the expectation that only a small percentage of these hits will correspond to a significant degree of alignment between the query sequence and the database sequence over a length greater than the w-mer length, it is desirable to filter out hits having a low probability of being part of a longer alignment. By filtering out such unpromising hits, the processing burden of the downstream ungapped extension stage and the gapped extension stage will be greatly reduced. As such, a hit filtering module is preferably employed in the seed generation stage to filter hits from the lookup table based at least in part upon whether a plurality of hits are determined to be sufficiently close to each other in the database sequence. In one embodiment, this hit filtering module comprises a two hit module that filters hits at least partially based upon whether two hits are determined to be sufficiently close to each other in the database sequence. To aid this determination, the two hit module preferably computes a diagonal index for each hit by calculating the difference between the query sequence position for the hit and the database sequence position for the hit. The two hit module can then decide to maintain a hit if another hit is found in the hit stream that shares the same diagonal index value and wherein the database sequence position for that another hit is within a pre-selected distance from the database sequence position of the hit under consideration.

The inventors herein further disclose that a plurality of hit filtering modules can be deployed in parallel within the seed generation stage on at least one hardware logic device (preferably at least one reconfigurable logic device such as at least one FPGA). When the hit filtering modules are replicated in the seed generation pipeline, a switch is also preferably deployed in the pipeline between the word matching module to selectively route hits to one of the plurality of hit filtering modules. This load balancing allows the hit filtering modules to process the hit stream produced by the word matching module with minimal delays. Preferably, this switch is configured to selectively route each hit in the hit stream. With such selective routing, each hit filtering module is associated with at least one diagonal index value. The switch then routes a given hit to the hit filtering module that is associated with the diagonal index value for that hit. Preferably, this selective routing employs modulo division routing. With modulo division routing, the destination hit filtering module for a given hit is identified by computing the diagonal index for that hit, modulo the number of hit filtering modules. The result of this computation identifies the particular hit filtering module to which that hit should be routed. If the number of replicated hit filtering modules in the pipeline comprises b, wherein b=2^{t}, then this modulo division routing can be implemented by having the switch check the least significant t bits of each hit's diagonal index value to determine the appropriate hit filtering module to which that hit should be routed. This switch can also be deployed on a hardware logic device, preferably a reconfigurable logic device such as an FPGA.

As yet another aspect of the seed generation stage, the inventors herein further disclose that throughput can be further enhanced by deploying a plurality of the word matching modules, or at least a plurality of the hit generators of the word matching module, in parallel within the pipeline on the hardware logic device (the hardware logic device preferably being a reconfigurable logic device such as an FPGA). A w-mer feeder upstream from the hit generator preferably selectively delivers the database w-mers of the database sequence to an appropriate one of the hit generators. With such a configuration, a plurality of the switches are also deployed in the pipeline, wherein each switch receives a hit stream from a different one of the parallel hit generators. Thus, in a preferred embodiment, if there are a plurality h of hit generators in the pipeline, then a plurality h of the above-described switches will also be deployed in the pipeline. To bridge the h switches to the b hit filtering modules, this design preferably also deploys a plurality T of buffered multiplexers. Each buffered multiplexer is connected at its output to one of the T hit filtering modules and preferably receives as inputs from each of the switches the modulo-routed hits that are destined for the downstream hit filtering module at its output. The buffered multiplexer then multiplexes the modulo-routed hits from multiple inputs to a single output stream. As disclosed herein, the buffered multiplexers are also preferably deployed in the pipeline in hardware logic, preferably reconfigurable logic such as that provided by an FPGA.

According to another aspect of a preferred embodiment of the present invention, the inventors herein disclose a design for deploying the ungapped extension stage of BLAST, particularly BLASTP, in hardware (preferably in reconfigurable logic such as an FPGA). The ungapped extension stage preferably passes only hits that qualify as high scoring pairs (HSPs), as determined over some extended window of the database sequence and query sequence near the hit, wherein the determination as to whether a hit qualifies as an HSP is based on a scoring matrix. From the scoring matrix, the ungapped extension stage can compute the similarity scores of nearby pairs of bases from the database and query. Preferably, this scoring matrix comprises a BLOSUM-62 scoring matrix. Furthermore, the scoring matrix is preferably stored in a BRAM unit deployed on a hardware logic device (preferably a reconfigurable logic device such as an FPGA).

According to another aspect of a preferred embodiment of the present invention, the inventors herein disclose a design for deploying the gapped extension stage of BLAST, particularly BLASTP, in hardware (preferably in reconfigurable logic such as an FPGA). The gapped extension stage preferably processes high scoring pairs to identify which hits correspond to alignments of interest for reporting back to the user. The gapped extension stage of this design employs a banded Smith-Waterman algorithm to find which hits pass this test. This banded Smith-Waterman algorithm preferably uses an HSP as a seed to define a band in which the Smith-Waterman algorithm is run, wherein the band is at least partially specified by a bandwidth parameter defined at compile time.

These and other features and advantages of the present invention will be described hereinafter to those having ordinary skill in the art.

### BRIEF DESCRIPTION OF THE DRAWINGS

FIG. 1 discloses an exemplary BLASTP pipeline for a preferred embodiment of the present invention;

FIGS. 2(a) and (b) illustrate an exemplary system into which the BLASTP pipeline of FIG. 1 can be deployed;

FIGS. 3(a)-(c) illustrate exemplary boards on which BLASTP pipeline functionality can be deployed;

FIG. 4 depicts an exemplary deployment of a BLASTP pipeline in hardware and software;

FIG. 5 depicts an exemplary word matching module for a seed generation stage of BLASTP;

FIG. 6(a) depicts a neighborhood of query w-mers produced from a given query w-mer;

FIG. 6(b) depicts an exemplary prune-and-search algorithm that can be used to perform neighborhood generation;

FIG. 6(c) depicts exemplary Single Instruction Multiple Data operations;

FIGS. 6(d) and 6(e) depict an exemplary vector implementation of a prune-and-search algorithm that can be used for neighborhood generation;

FIG. 7(a) depicts an exemplary protein biosequence that can be retrieved from a database and streamed through the BLASTP pipeline;

FIG. 7(b) depicts exemplary database w-mers produced from the database sequence of FIG. 7(a);

FIG. 8 depicts an exemplary base conversion unit for deployment in the word matching module of the BLASTP pipeline;

FIG. 9 depicts an example of how lookups are performed in a lookup table of a hit generator within the word matching module to find hits between the query w-mers and the database w-mers;

FIG. 10 depicts a preferred algorithm for modular delta encoding query positions into the lookup table of the hit generator;

FIG. 11 depicts an exemplary hit compute unit for decoding hits found in the lookup table of the hit generator;

FIGS. 12(a) and 12(b) depict a preferred algorithm for finding hits with the hit generator;

FIG. 13 depicts an example of how a hit filtering module of the seed generation stage can operate to filter hits;

FIGS. 14(a) and (b) depict examples of functionality provided by a two hit module;

FIG. 15 depicts a preferred algorithm for filtering hits with a two hit module;

FIG. 16 depicts an exemplary two hit module for deployment in the seed generation stage of the BLASTP pipeline;

FIG. 17 depicts an example of how multiple parallel hit filtering modules can be deployed in the seed generation stage of the BLASTP pipeline;

FIGS. 18(a) and (b) comparatively illustrate a load distribution of hits for two types of routing of hits to parallel hit filtering modules;

FIG. 19 depicts an exemplary switch module for deployment in the seed generation stage of the BLASTP pipeline to route hits to the parallel hit filtering modules;

FIG. 20 depicts an exemplary buffered multiplexer for bridging each switch module of FIG. 19 with a hit filtering module;

FIG. 21 depicts an exemplary seed generation stage for deployment in the BLASTP pipeline that provides parallelism through replicated modules;

FIG. 22 depicts an exemplary software architecture for implementing the BLASTP pipeline;

FIG. 23 depicts an exemplary ungapped extension analysis stage for a BLASTP pipeline;

FIG. 24 depicts an exemplary scoring technique for ungapped extension analysis within a BLASTP pipeline; and

FIG. 25 depicts an example of the computational space for a banded Smith-Waterman algorithm;

FIGS. 26(a) and (b) depict a comparison of the search space as between NCBI BLASTP employing X-drop and banded Smith-Waterman;

FIG. 27 depicts a Smith-Waterman recurrence in accordance with an embodiment of the invention;

FIG. 28 depicts an exemplary FPGA on which a banded Smith-Waterman prefilter stage has been deployed;

FIG. 29 depicts an exemplary threshold table and start table for use with a banded Smith-Waterman prefilter stage;

FIG. 30 depicts an exemplary banded Smith-Waterman core for the prefilter stage of FIG. 28;

FIG. 31 depicts an exemplary MID register block for the prefilter stage of FIG. 28;

FIG. 32 depicts an exemplary query shift register and database shift register for the prefilter stage of FIG. 28;

FIG. 33 depicts an exemplary individual Smith-Waterman cell for the prefilter stage of FIG. 28; and

FIGS. 34, 35(a) and 35(b) depict exemplary process flows for creating a template to be loaded onto a hardware logic device.

### DETAILED DESCRIPTION OF THE PREFERRED EMBODIMENTS

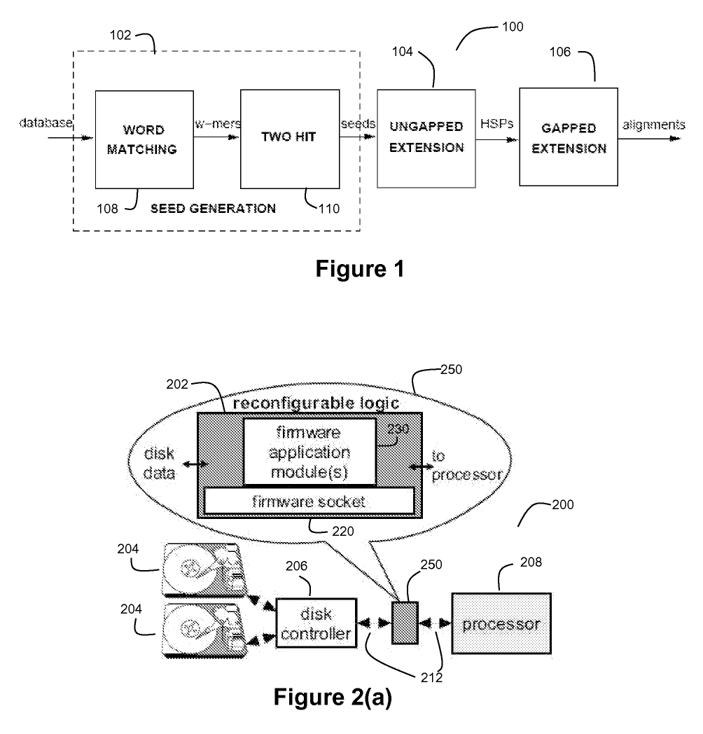

FIG. 1 depicts an exemplary BLASTP pipeline 100 for a preferred embodiment of the present invention. The BLASTP algorithm is preferably divided into three stages (a first stage 102 for Seed Generation, a second stage 104 for Ungapped Extension, and a third stage 106 for Gapped Extension).

As used herein, the term “stage” refers to a functional process or group of processes that transforms/converts/calculates a set of outputs from a set of inputs. It should be understood to those of ordinary skill in the art that, any two or more “stages” could be combined and yet still be covered by this definition as a stage may itself comprise a plurality of stages.

One observation in the BLASTP technique is the high likelihood of the presence of short aligned words (or w-mers) in an alignment. Seed generation stage 102 preferably comprises a word matching module 108 and a hit filtering module 110. The word matching module 108 is configured find a plurality of hits between substrings (or words) of a query sequence (referred to as query w-mers) and substrings (or words) of a database sequence (referred to as database w-mers). The word matching module is preferably keyed with the query w-mers corresponding to the query sequence prior to the database sequence being streamed therethrough. As an input, the word matching module receives a bit stream comprising a database sequence and then operates to find hits between database w-mers produced from the database sequence and the query w-mers produced from the query sequence, as explained below in greater detail. The hit filtering module 110 receives a stream of hits from the word matching module 108 and decides whether the hits show sufficient likelihood of being part of a longer alignment between the database sequence and the query sequence. Those hits passing this test by the hit filtering module are passed along to the ungapped extension stage 104 as seeds. In a preferred embodiment, the hit filtering module is implemented as a two hit module, as explained below.

The ungapped extension stage 104 operates to process the seed stream received from the first stage 102 and determine which of those hits qualify as high scoring pairs (HSPs). An HSP is a pair of continuous subsequences of residues (identical or not, but without gaps at this stage) of equal length, at some location in the query sequence and the database sequence. Statistically significant HSPs are then passed into the gapped extension stage 106, where a Smith-Waterman-like dynamic programming algorithm is performed. An HSP that successfully passes through all three stages is reported to the user.

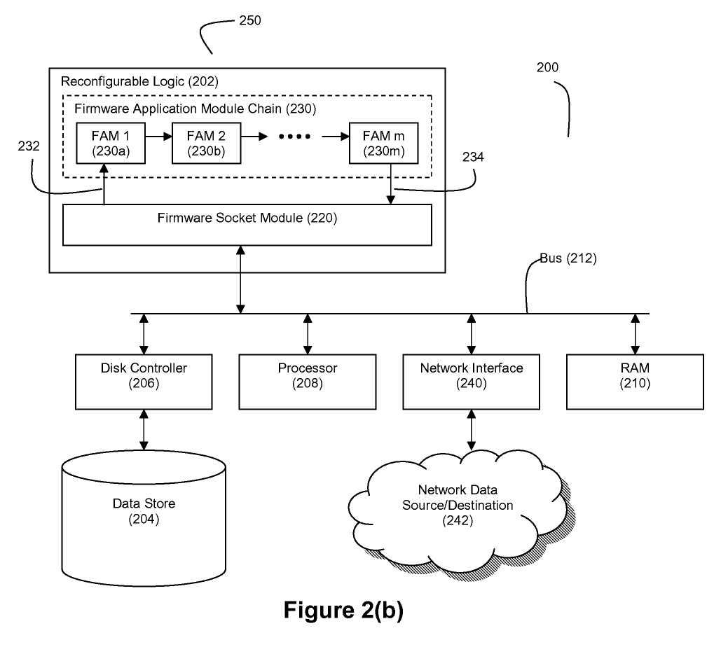

FIGS. 2(a) and (b) depict a preferred system 200 in which the BLASTP pipeline of FIG. 1 can be deployed. In one embodiment, all stages of the FIG. 1 BLASTP pipeline 100 are implemented in hardware on a board 250 (or boards 250).

However, it should be noted that all three stages need not be fully deployed in hardware to achieve some degree of higher throughput for BLAST (particularly BLASTP) relative to conventional software-based BLAST processing. For example, a practitioner of the present invention may choose to implement only the seed generation stage in hardware. Similarly, a practitioner of the present invention may choose to implement only the ungapped extension stage in hardware (or even only a portion thereof in hardware, such as deploying a prefilter portion of the ungapped extension stage in hardware). Further still, a practitioner of the present invention may choose to implement only the gapped extension stage in hardware (or even only a portion thereof in hardware, such as deploying a prefilter portion of the gapped extension stage in hardware). FIG. 4 depicts an exemplary embodiment of the invention wherein the seed generation stage (comprising a word matching module 108 and hit filtering module 110), the ungapped extension stage 400 and a prefilter portion 402 of the gapped extension stage are deployed in hardware such as reconfigurable logic device 202. The remainder of the gapped extension stage of processing is performed via a software module 404 executed by a processor 208. FIG. 22 depicts a similar embodiment albeit with the first two stages being deployed on a first hardware logic device (such as an FPGA) with the third stage prefilter 402 being deployed on a second hardware logic device (such as an FPGA).

Board 250 comprises at least one hardware logic device. As used herein, “hardware logic device” refers to a logic device in which the organization of the logic is designed to specifically perform an algorithm and/or application of interest by means other than through the execution of software. For example, a general purpose processor (GPP) would not fall under the category of a hardware logic device because the instructions executed by the GPP to carry out an algorithm or application of interest are software instructions. As used herein, the term “general-purpose processor” refers to a hardware device that fetches instructions and executes those instructions (for example, an Intel Xeon processor or an AMD Opteron processor). Examples of hardware logic devices include Application Specific Integrated Circuits (ASICs) and reconfigurable logic devices, as more fully described below.

The hardware logic device(s) of board 250 is preferably a reconfigurable logic device 202 such as a field programmable gate array (FPGA). The term “reconfigurable logic” refers to any logic technology whose form and function can be significantly altered (i.e., reconfigured) in the field post-manufacture. This is to be contrasted with a GPP, whose function can change post-manufacture, but whose form is fixed at manufacture. This can also be contrasted with those hardware logic devices whose logic is not reconfigurable, in which case both the form and the function is fixed at manufacture (e.g., an ASIC).

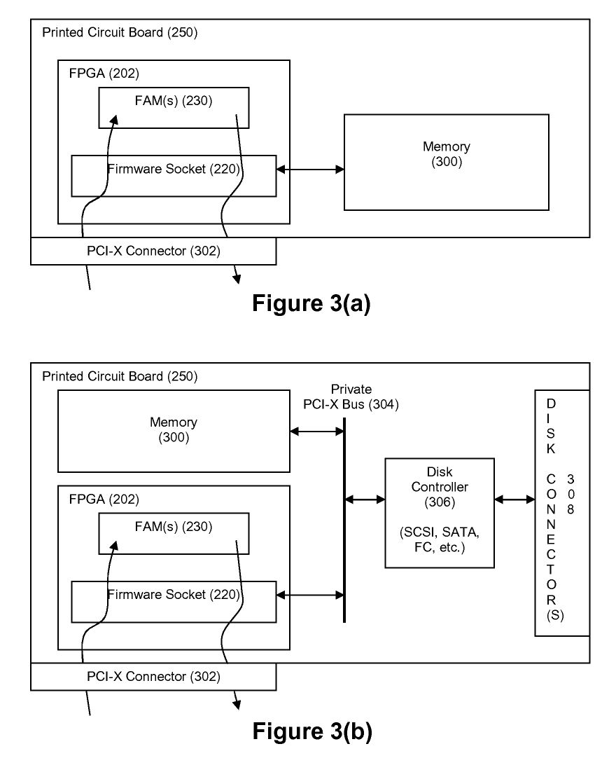

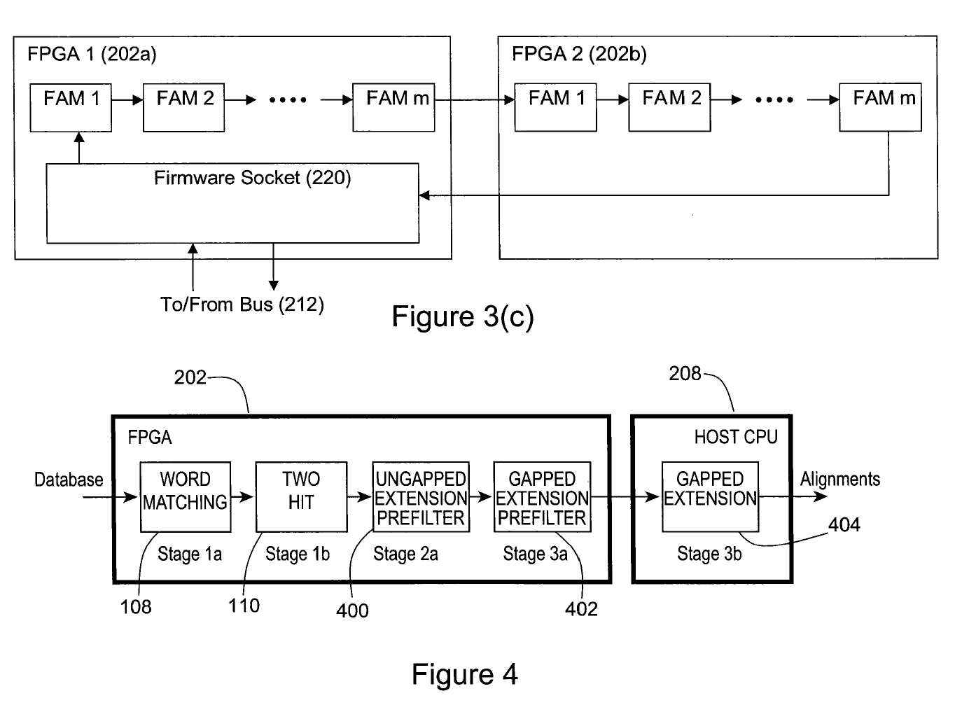

In this system, board 250 is positioned to receive data that streams off either or both a disk subsystem defined by disk controller 206 and data store(s) 204 (either directly or indirectly by way of system memory such as RAM 210). The board 250 is also positioned to receive data that streams in from and a network data source/destination 242 (via network interface 240). Preferably, data streams into the reconfigurable logic device 202 by way of system bus 212, although other design architectures are possible (see FIG. 3(b)). Preferably, the reconfigurable logic device 202 is an FPGA, although this need not be the case. System bus 212 can also interconnect the reconfigurable logic device 202 with the computer system's main processor 208 as well as the computer system's RAM 210. The term “bus” as used herein refers to a logical bus which encompasses any physical interconnect for which devices and locations are accessed by an address. Examples of buses that could be used in the practice of the present invention include, but are not limited to the PCI family of buses (e.g., PCI-X and PCI-Express) and HyperTransport buses. In a preferred embodiment, system bus 212 may be a PCI-X bus, although this need not be the case.

The data store(s) 204 can be any data storage device/system, but is preferably some form of a mass storage medium. For example, the data store(s) 204 can be a magnetic storage device such as an array of Seagate disks. However, it should be noted that other types of storage media are suitable for use in the practice of the invention. For example, the data store could also be one or more remote data storage devices that are accessed over a network such as the Internet or some local area network (LAN). Another source/destination for data streaming to or from the reconfigurable logic device 202, is network 242 by way of network interface 240, as described above.

The computer system defined by main processor 208 and RAM 210 is preferably any commodity computer system as would be understood by those having ordinary skill in the art. For example, the computer system may be an Intel Xeon system or an AMD Opteron system.

The reconfigurable logic device 202 has firmware modules deployed thereon that define its functionality. The firmware socket module 220 handles the data movement requirements (both command data and target data) into and out of the reconfigurable logic device, thereby providing a consistent application interface to the firmware application module (FAM) chain 230 that is also deployed on the reconfigurable logic device. The FAMs 230i of the FAM chain 230 are configured to perform specified data processing operations on any data that streams through the chain 230 from the firmware socket module 220. Preferred examples of FAMs that can be deployed on reconfigurable logic in accordance with a preferred embodiment of the present invention are described below. The term “firmware” will refer to data processing functionality that is deployed on reconfigurable logic. The term “software” will refer to data processing functionality that is deployed on a GPP (such as processor 208).

The specific data processing operation that is performed by a FAM is controlled/parameterized by the command data that FAM receives from the firmware socket module 220. This command data can be FAM-specific, and upon receipt of the command, the FAM will arrange itself to carry out the data processing operation controlled by the received command. For example, within a FAM that is configured to perform sequence alignment between a database sequence and a first query sequence, the FAM's modules can be parameterized to key the various FAMs to the first query sequence. If another alignment search is requested between the database sequence and a different query sequence, the FAMs can be readily re-arranged to perform the alignment for a different query sequence by sending appropriate control instructions to the FAMs to re-key them for the different query sequence.

Once a FAM has been arranged to perform the data processing operation specified by a received command, that FAM is ready to carry out its specified data processing operation on the data stream that it receives from the firmware socket module. Thus, a FAM can be arranged through an appropriate command to process a specified stream of data in a specified manner. Once the FAM has completed its data processing operation, another command can be sent to that FAM that will cause the FAM to re-arrange itself to alter the nature of the data processing operation performed thereby, as explained above. Not only will the FAM operate at hardware speeds (thereby providing a high throughput of target data through the FAM), but the FAMs can also be flexibly reprogrammed to change the parameters of their data processing operations.

The FAM chain 230 preferably comprises a plurality of firmware application modules (FAMs) 230a, 230b, . . . that are arranged in a pipelined sequence. As used herein, “pipeline”, “pipelined sequence”, or “chain” refers to an arrangement of FAMs wherein the output of one FAM is connected to the input of the next FAM in the sequence. This pipelining arrangement allows each FAM to independently operate on any data it receives during a given clock cycle and then pass its output to the next downstream FAM in the sequence during another clock cycle.

A communication path 232 connects the firmware socket module 220 with the input of the first one of the pipelined FAMs 230a. The input of the first FAM 230a serves as the entry point into the FAM chain 230. A communication path 234 connects the output of the final one of the pipelined FAMs 230m with the firmware socket module 220. The output of the final FAM 230m serves as the exit point from the FAM chain 230. Both communication path 232 and communication path 234 are preferably multi-bit paths.

FIG. 3(a) depicts a printed circuit board or card 250 that can be connected to the PCI-X bus 212 of a commodity computer system for use in implementing a BLASTP pipeline. In the example of FIG. 3(a), the printed circuit board includes an FPGA 202 (such as a Xilinx Virtex II FPGA) that is in communication with a memory device 300 and a PCI-X bus connector 302. A preferred memory device 300 comprises SRAM and DRAM memory. A preferred PCI-X bus connector 302 is a standard card edge connector.

FIG. 3(b) depicts an alternate configuration for a printed circuit board/card 250. In the example of FIG. 3(b), a private bus 304 (such as a PCI-X bus), a disk controller 306, and a disk connector 308 are also installed on the printed circuit board 250. Any commodity disk connector technology can be supported, as is understood in the art. In this configuration, the firmware socket 220 also serves as a PCI-X to PCI-X bridge to provide the processor 208 with normal access to the disks connected via the private PCI-X bus 306.

It is worth noting that while a single FPGA 202 is shown on the printed circuit boards of FIGS. 3(a) and (b), it should be understood that multiple FPGAs can be supported by either including more than one FPGA on the printed circuit board 250 or by installing more than one printed circuit board 250 in the computer system. FIG. 3(c) depicts an example where numerous FAMs in a single pipeline are deployed across multiple FPGAs.

Additional details regarding the preferred system 200, including FAM chain 230 and firmware socket module 220, for deployment of the BLASTP pipeline are found in the following patent applications: U.S. patent application Ser. No. 09/545,472 (filed Apr. 7, 2000, and entitled “Associative Database Scanning and Information Retrieval”, now U.S. Pat. No. 6,711,558), U.S. patent application Ser. No. 10/153,151 (filed May 21, 2002, and entitled “Associative Database Scanning and Information Retrieval using FPGA Devices”, now U.S. Pat. No. 7,139,743), published PCT applications WO 05/048134 and WO 05/026925 (both filed May 21, 2004, and entitled “Intelligent Data Storage and Processing Using FPGA Devices”), U.S. patent application Ser. No. 11/359,285 (filed Feb. 22, 2006, entitled “Method and Apparatus for Performing Biosequence Similarity Searching” and published as U.S. Patent Application Publication 2007/0067108), U.S. patent application Ser. No. 11/293,619 (filed Dec. 2, 2005, and entitled “Method and Device for High Performance Regular Expression Pattern Matching” and published as U.S. Patent Application Publication 2007/0130140), U.S. patent application Ser. No. 11/339,892 (filed Jan. 26, 2006, and entitled “Firmware Socket Module for FPGA-Based Pipeline Processing” and published as U.S. Patent Application Publication 2007/0174841), and U.S. patent application Ser. No. 11/381,214 (filed May 2, 2006, and entitled “Method and Apparatus for Approximate Pattern Matching”), the entire disclosures of each of which are incorporated herein by reference.

### 1. Seed Generation Stage 102

1.A. Word Matching Module 108

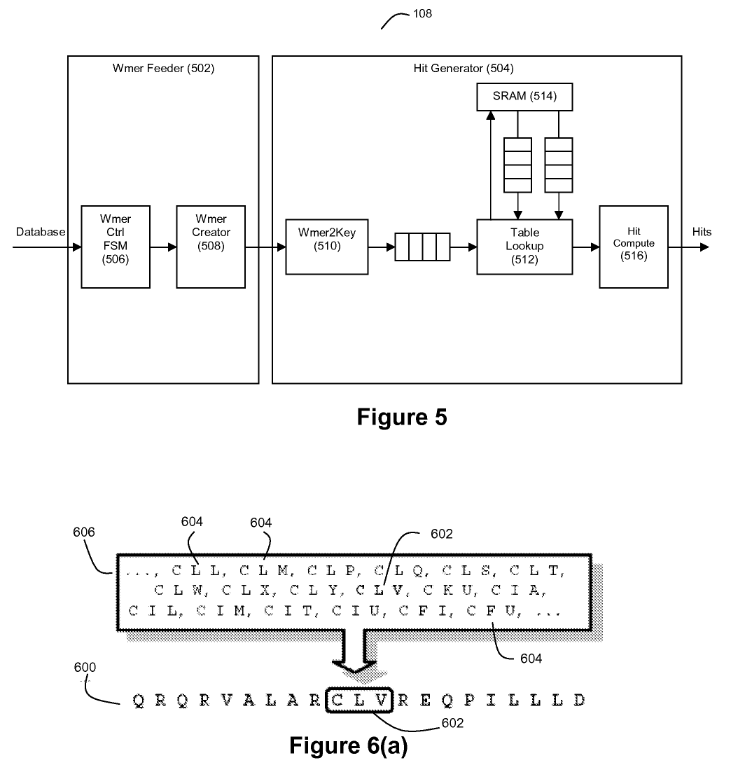

FIG. 5 depicts a preferred block diagram of the word matching module 108 in hardware. The word matching module is preferably divided into two logical components: the w-mer feeder 502 and the hit generator 504.

The w-mer feeder 502 preferably exists as a FAM 230 and receives a database stream from the data store 204 (by way of the firmware socket 220). The w-mer feeder 502 then constructs fixed length words to be scanned against the a query neighborhood. Preferably, twelve 5-bit database residues are accepted in each clock cycle by the w-mer control finite state machine unit 506. The output of this stage 502 is a database w-mer and its position in the database sequence. The word length w of the w-mers is defined by the user at compile time.

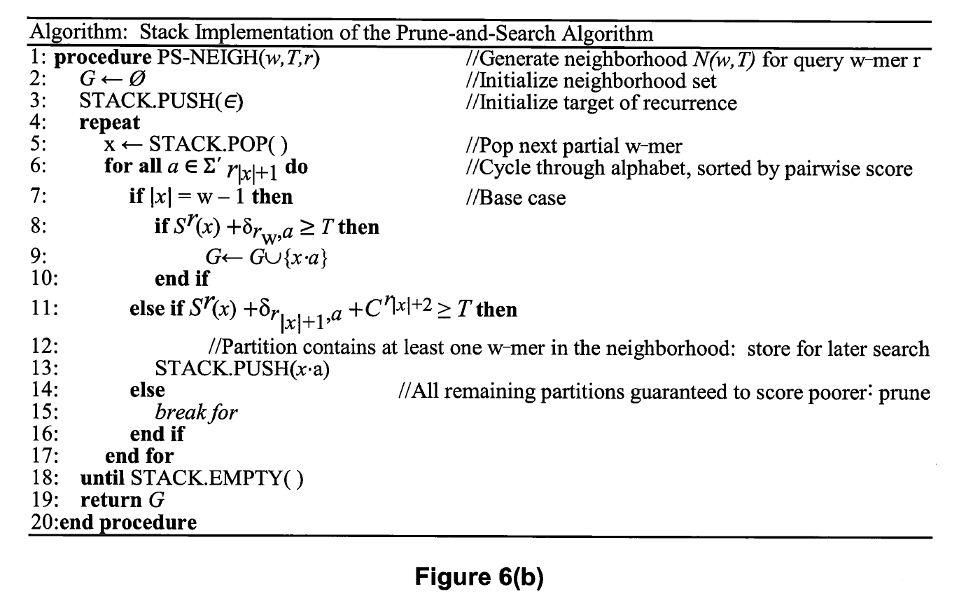

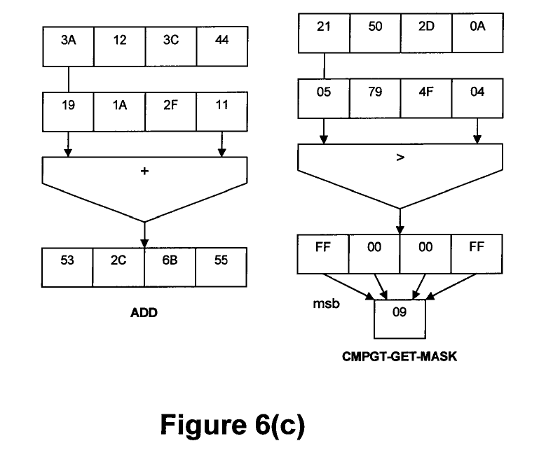

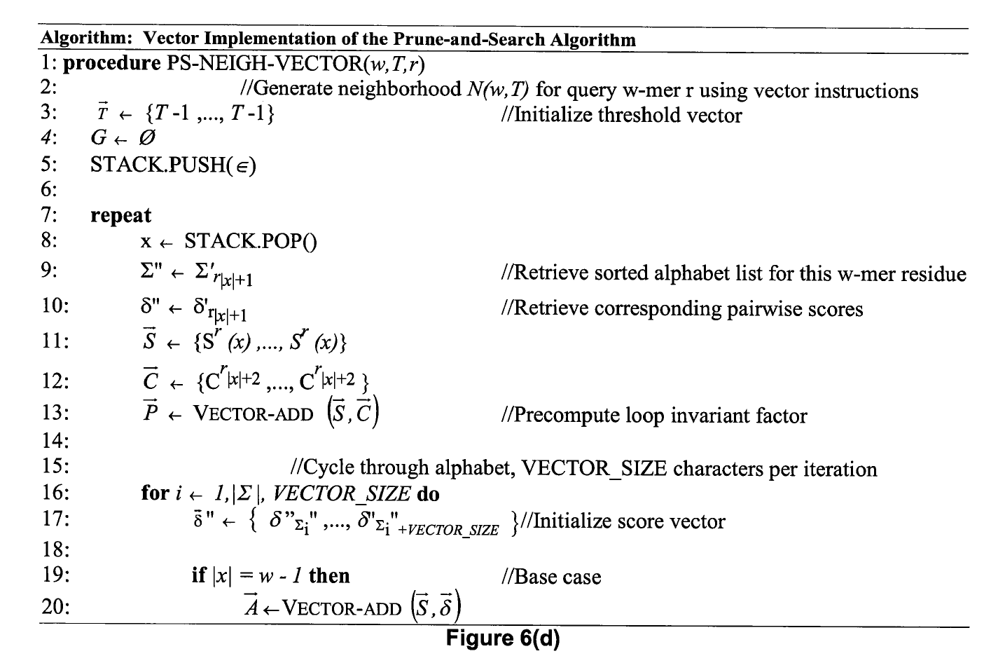

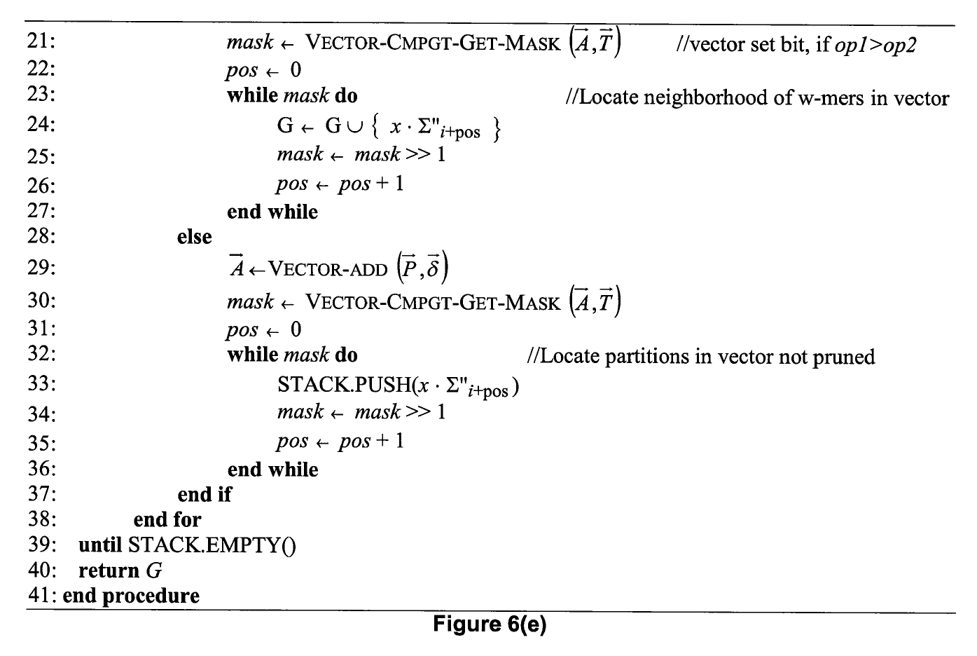

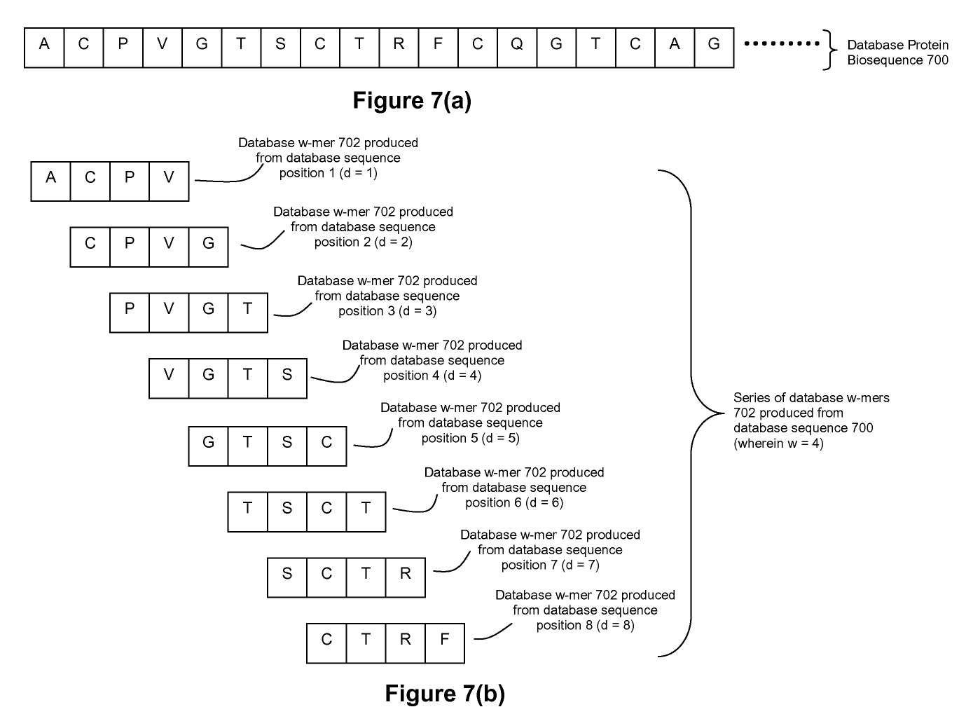

The w-mer creator unit 508 is a structural module that generates the database w-mer for each database position. FIGS. 6 and 7 illustrate an exemplary output from unit 508. FIG. 7(a) depicts an exemplary database protein sequence 700 comprising a serial stream of residues. From the database sequence 700, a plurality of database w-mers 702 are created, as shown in FIG. 7(b). In the example of FIG. 7(b), the w-mer length w is equal to 4 residues, and the corresponding database w-mer 702 for the first 8 database positions are shown.

W-mer creator unit 508 can readily be designed to enable various word lengths, masks (discontiguous residue position taps), or even multiple database w-mers based on different masks. Another function of the module 508 is to flag invalid database w-mers. While NCBI BLASTP supports an alphabet size of 24 (20 amino acids, 2 ambiguity characters and 2 control characters), a preferred embodiment of the present invention restricts this alphabet to only the 20 amino acids. Database w-mers that contain residues not representing the twenty amino acids are flagged as invalid and discarded by the seed generation hardware. This stage is also capable of servicing multiple consumers in a single clock cycle. Up to M consecutive database w-mers can be routed to downstream sinks based on independent read signals. This functionality is helpful to support multiple parallel hit generator modules, as described below. Care can also be taken to eliminate dead cycles; the w-mer feeder 502 is capable of satisfying up to M requests in every clock cycle.

The hit generator 504 produces hits from an input database w-mer by querying a lookup table stored in memory 514. In a preferred embodiment, this memory 514 is off-chip SRAM (such as memory 300 in FIG. 3(a)). However, it should be noted that memory devices other than SRAM can be used as memory 514 (e.g., SDRAM). Further still, with currently available FPGAs, an FPGA's available on-chip memory resources are not likely sufficient to satisfy the storage needs of the lookup table. However, as improvements are made to FPGAs in the future that increase the on-chip storage capacity of FPGAs, the inventors herein note that memory 514 can also be on-chip memory resident on the FPGA.

The hardware pipeline of the hit generator 504 preferably comprises a base conversion unit 510, a table lookup unit 512, and a hit compute module 516.

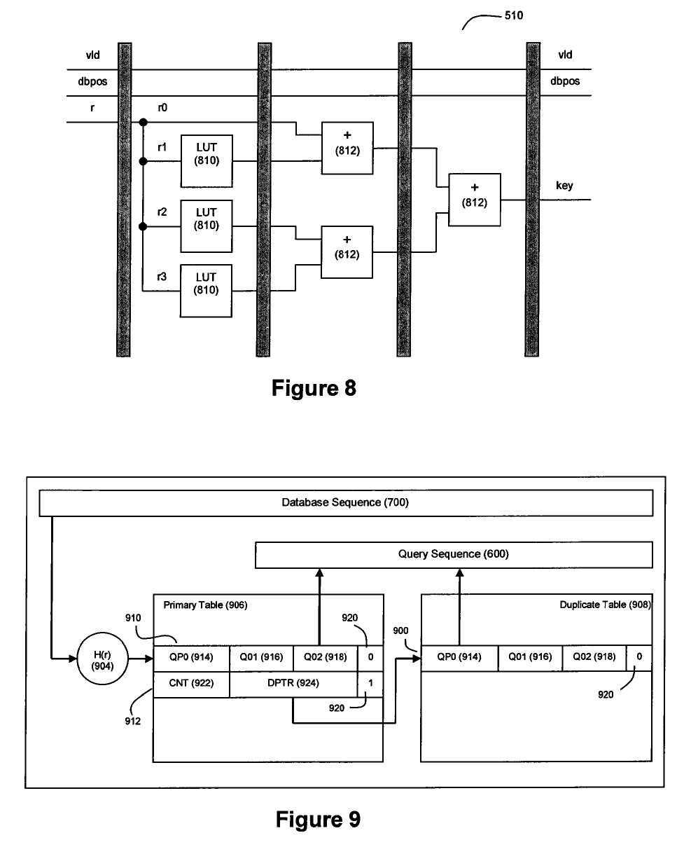

A direct memory lookup table 514 stores the position(s) in the query sequence to which every possible w-mer maps. The twenty amino acids are represented using 5 bits. A direct mapping of a w-mer to the lookup table requires a large lookup table with 2^{5w} entries. However, of these 2^{5w} entries, only 20^{w} specify a valid w-mer. Therefore, a change of base to an optimal base is preferably performed by the base conversion unit 510 using the formula below:
Key=20^{w-1}r_{w-1}+20^{w-2}r_{w-2}+K+r₀
where rᵢ is the i^{th} residue of the w-mer. For a fixed word length (which is set during compile time), this computation is easily realized in hardware, as shown in FIG. 8. It should also be noted that the base conversion can be calculated using Horner's rule.

The base conversion unit 510 of FIG. 8 shows a three-stage w-mer-to-key conversion for w=4. A database w-mer r, at position dbpos is converted to the key in stages. Simple lookup tables 810 are used in place of hardware multipliers (since the alphabet size is fixed) to multiply each residue in the w-mer. The result is aggregated using an adder tree 812. In the example of FIG. 8, wherein w=4, it should be noted that the optimal base selection provided by the base conversion unit allows for the size of the lookup table to be reduced from 1,048,576 entries (or 2⁵*⁴) to 160,000 entries (or 20⁴), providing a storage space reduction of approximately 6.5×.

As noted above, the hit generator 504 identifies hits, and a hit is preferably identified by a (q, d) pair that corresponds to a pair of aligned w-mers (the pair being a query w-mer and a database w-mer) at query sequence offset q and database sequence offset d. Thus, q serves as a position identifier for identifying where in the query sequence a query w-mer is located that serves as a “hit” on a database w-mer. Likewise, d serves as a position identifier for locating where in the database sequence that database w-mer serving as the basis of the “hit” is located.

To aid this process, the neighborhood of a query sequence is generated by identifying all overlapping words of a fixed length, termed a “w-mer”. A w-mer in the neighborhood acts as an index to one or more positions in the query. Linear scanning of overlapping words in the database sequence, using a lookup table constructed from the neighborhood helps in quick identification of hits, as explained below.

Due to the high degree of conservation in DNA sequences, BLASTN word matches are simply pairs of exact matches in both sequences (with the default word length being 11). Thus, with BLASTN, building the neighborhood involves identifying all N−w+1 overlapping w-mers in a query sequence of length N. However, for protein sequences, amino acids readily mutate into other, functionally similar amino acids. Hence, BLASTP looks for shorter (typically of length w=3) non-identical pairs of substrings that have a high similarity score. Thus, with word matching in BLASTP, “hits” between database w-mers and query w-mers include not only hits between a database w-mer and its exactly matching query w-mer, but also any hits between a database w-mer and any of the query w-mers within the neighborhood of the exactly matching query w-mer. In BLASTP, the neighborhood N(w, T) is preferably generated by identifying all possible amino acid subsequences of size w that match each overlapping w-mer in the query sequence. All such subsequences that score at least T (called the neighborhood threshold) when compared to the query w-mer are added to the neighborhood. FIG. 6(a) illustrates a neighborhood 606 of query w-mers that are deemed a match to a query w-mer 602 present in query sequence 600. As can be seen in FIG. 6(a), the neighborhood 606 includes not only the exactly matching query w-mer 602, but also nonexact matches 604 that are deemed to fall within the neighborhood of the query w-mer, as defined by the parameters w and T. Preferably, a query sequence preprocessing operation (preferably performed in software prior to compiling the pipeline for a given search) compares each query w-mer against an enumerated list of all |Σ|^{w} possible words (where Σ is the alphabet) to determine the neighborhood.

Neighborhood generation is preferably performed by software as part of a query pre-processing operation (see FIG. 22). Any of a number of algorithms can be used to generate the neighborhood. For example, a naïve algorithm can be used that (1) scores all possible 20^{w} w-mers against every w-mer in the query sequence, and (2) adds those w-mers that score above T into the neighborhood.

However, such a naïve algorithm can be both memory- and computationally-intensive, degrading exponentially as longer word lengths. As an alternative, a prune-and-search algorithm can be used to generate the neighborhood. Such a prune-and-search algorithm has the same worst-case bound as the naïve algorithm, but is believed to show practical improvements in speed. The prune-and-search algorithm divides the search space into a number of independent partitions, each of which is inspected recursively. At each step, it is possible to determine if there exists at least one w-mer in the partition that must be added to the neighborhood. This decision can be made without the costly inspection of all w-mers in the partition. Such w-mer partitions are pruned from the search process. Another advantage of a prune-and-search algorithm is that it can be easily parallelized.

Given a query w-mer r, the alphabet Σ, and a scoring matrix 6, the neighborhood of the w-mer can be computed using the recurrence shown below, wherein the neighborhood N(w, T) of the query Q is the union of the individual neighborhoods of every query w-mer r ε Q.

$$N ( w , T ) = {Y}_{r ∈ Q} {G}^{r} ( ∈ , w , T )$$

$${G}^{r} ( x , w , T ) = {Y}_{a ∈ \sum } \{ \begin{matrix} \{ xa \} & \begin{matrix}if \vert x \vert = w - 1 and \\ {S}^{r} ( x ) + {δ}_{{r}_{w} , a} \geq T ,\end{matrix} \\ {G}^{r} ( xa , w , t ) & \begin{matrix}if \vert x \vert < w - 1 and \\ {S}^{r} ( x ) + {δ}_{{r}_{\vert x \vert + 1} , a} + \\ {C}^{r} ( \vert x \vert + 1 ) \geq T ,\end{matrix} \\ ϕ & otherwise\end{matrix} \\ {S}^{r} ( x ) = \{ \begin{matrix} 0 & if x = ∈ , \\ {S}^{r} ( y ) + {δ}_{{r}_{\vert x \vert} , a} & otherwise , where x = ya .\end{matrix} \} \\ {C}^{r} ( i ) = \{ \begin{matrix} {max}_{a ∈ \sum } {δ}_{{r}_{w} , a} & if i = w - 1 , \\ {max}_{a ∈ \sum } {δ}_{{r}_{i} , a} + {C}^{r} ( i + 1 ) & otherwise .\end{matrix} \}$$

G^{r}(x,w,T) is the set of all w-mers in N^{r}(w,T) having the prefix x, wherein x can be termed a partial w-mer. The base is G^{r}(x,w,T) where |x|=w−1 and the target is to compute G^{r}(ε,w,T). At each step of the recurrence, the prefix x is extended by one character a ε Σ. The pruning process is invoked at this stage. If it can be determined that no w-mers with a prefix xa exist in the neighborhood, all such w-mers are pruned; otherwise the partition is recursively inspected. The score of xa is also computed and stored in S^{r}(xa). The base case of the recurrence occurs when |xa|=w−1. At this point, it is possible to determine conclusively if the w-mer scores above the neighborhood threshold.

For the pruning step, during the extension of x by a, the highest score of any w-mer in N^{r}(w,T) with the prefix xa is determined. This score is computed as the sum of three parts: the score of x against the pairwise score of a against the character r_{|x|+1}, and the highest score of some suffix string y and r_{|x|+2 . . . w} with |xay|=w. The three score values are computed by constant-time table lookups into S^{r}, δ, and C^{r} respectively. C^{r}(i) holds the score of the highest scoring suffix y of some w-mer in N^{r}(w,T), where |y|=w−i. This can be easily computed in linear time using the score matrix.

A stack implementation of the computation of G^{r}(e,w,T) is shown in FIG. 6(b). The algorithm of FIG. 6(b) performs a depth-first search of the neighborhood, extending a partial w-mer by every character in the alphabet. One can define Σ′_{b} to be the alphabet sorted in descending order of the pairwise score against character b in δ. The w-mer extension is performed in this order, causing the contribution of the δlookup in the left-hand side of the expression on line 12 of FIG. 6(b) to progressively diminish with every iteration. Hence, as soon as a partition is pruned, further extension by the remaining characters in the list can be halted.

As partial w-mers are extended, a larger number of partitions are discarded. The fraction of the neighborhood discarded at each step depends on the scoring matrix δ and the threshold T. While in the worst case scenario the algorithm of FIG. 6(b) takes exponential time in w, in practice the choice of the parameters allows for significant improvements in speed relative to naïve enumeration.

As another alternative to the naïve algorithm, a vector implementation of the prune-and-search algorithm that employs Single Instruction Multiple Data (SIMD) technology available on a host CPU can be used to accelerate the neighborhood generation. SIMD instructions exploit data parallelism in algorithms by performing the same operation on multiple data values. The instruction set architectures of most modern GPPs are augmented with SIMD instructions that offer increasingly complex functionality. Existing extensions include SSE2 on x86 architectures and AltiVec on PowerPC cores, as is known in the art.

Sample SIMD instructions are illustrated in FIG. 6(c). The vector addition of four signed 8-bit operand pairs is performed in a single clock cycle, decreasing the execution time to one-fourth. The number of data values in the SIMD register (Vector Size) and their precision are implementation-dependent. The Cmpgt-Get-Mask instruction checks to see if signed data values in the first vector are greater than those in the second. This operation is performed in two steps. First, a result value of all ones if the condition is satisfied (or zero if otherwise) is created. Second, a signed extended mask is formed from the most significant bits of the individual data values. The mask is returned in an integer register that must be inspected sequentially to determine the result of the compare operation.

Prune-and-search algorithms partition a search problem into a number of subinstances that are independent of each other. With the exemplary prune-and-search algorithm, the extensions of a partial w-mer by every character in the alphabet can be performed independently of each other. The resultant data parallelism can then be exploited by vectorizing the computation in the “for” loop of the algorithm of FIG. 6(b).

FIGS. 6(d) and 6(e) illustrate a vector implementation of the prune-and-search algorithm. As in the sequential version, each partial w-mer is extended by every character in the alphabet. However, each iteration of the loop performs VECTOR_SIZE such simultaneous extensions. As previously noted, a sorted alphabet list is used for extension. The sequential add operation is replaced by the vector equivalent, Vector-Add. Lines 21-27 of FIG. 6(e) perform the comparison operation and inspect the result. The returned mask value is shifted right, and the least significant bit is inspected to determine the result of the comparison operation for each operand pair. Appropriate sections are executed according to this result. The lack of parallelism in statements 22−27 results in sequential code.

SSE2 extensions available on a host CPU can be used for implementing the algorithm of FIGS. 6(d) and 6(e). A vector size of 16 and signed 8-bit integer data values can also be used. The precision afforded by such an implementation is sufficient for use with typical parameters without overflow or underflow exceptions. Saturated signed arithmetic can be used to detect overflow/underflow and clamp the result to the largest/smallest value. The alphabet size can be increased to the nearest multiple of 16 by introducing dummy characters, and the scoring matrix can be extended accordingly.

Table 1 below compares the neighborhood generation times of the three neighborhood generation algorithms discussed above, wherein the NCBI-BLAST algorithm represents the naïve algorithm. The run times were averaged over twenty runs on a 2048-residue query sequence. The benchmark machine was a 2.0 GHz AMD Opteron workstation with 6 GB of memory.

TABLE 1
Comparison of Runtimes (in Seconds) of Various
Neighborhood Generation Algorithms

| N(w, T) | NCBI-BLAST | Prune-Search | Vector-Prune-Search |
|---|---|---|---|
| N(4, 13) | 0.4470 | 0.0780 | 0.0235 |
| N(4, 11) | 0.9420 | 0.1700 | 0.0515 |
| N(5, 13) | 25.4815 | 1.3755 | 0.4430 |
| N(5, 11) | 36.2765 | 2.6390 | 0.7835 |
| N(6, 13) | 1,097.2388 | 16.0855 | 5.2475 |

As can be seen from Table 1, the prune-and-search algorithm is approximately 5× faster than the naïve NCBI-BLAST algorithm for w=4. Furthermore, it can be seen that the performance of the naïve NCBI-BLAST algorithm degrades drastically with increasing word lengths. For example, at w=6, the prune-and-search algorithm is over 60× faster. It can also be seen that the vector implementation shows a speed-up of around 3× over the sequential prune-and-search method.

It should be noted that a tradeoff exists between speed and sensitivity when selecting the neighborhood parameters. Increasing the word length or the neighborhood threshold decreases the neighborhood size, and therefore reduces the computational costs of seed generation, since fewer hits are generated. However, this comes at the cost of decreased sensitivity. Fewer word matches are generated from the smaller neighborhood, reducing the probability of a hit in a biologically relevant alignment.

The neighborhood of a query w-mer is stored in a direct lookup table 514 indexed by w-mers (preferably indirectly indexed by the w-mers when optimal base selection is used to compute a lookup table index key as described in connection with the base conversion unit 510). A linear scan of the database sequence performs a lookup in the lookup table 514 for each overlapping database w-mer r at database offset d. The table lookup yields a linked list of query offsets q₁, q₂, . . . , qₙ which correspond to hits (q₁, d₁), (q₂, d₂), . . . , (qₙ, dₙ). Hits generated from a table lookup may be further processed to generate seeds for the ungapped extension stage.

Thus, as indicated, the table lookup unit 512 generates hits for each database w-mer. The query neighborhood is stored in the lookup table 514 (embodied as off-chip SRAM in one embodiment). Preferably, the lookup table 514 comprises a primary table 906 and a duplicate table 908, as described below in connection with FIG. 9. Described herein will be a preferred embodiment wherein the lookup table is embodied in a 32-bit addressable SRAM; the lookup table being configured to store query positions for a 2048-residue query sequence. For a query sequence having a residue length of 2048 and for a w-mer length w of 3, it should be noted that 11 bits (2¹¹=2048) would be needed to directly represent the 2046 possible query positions for query w-mers in the query sequence.

With reference to FIG. 9, the primary table 906 is a direct memory lookup table containing 20^{w} 32-bit entries, one entry for every possible w-mer in a database sequence. Each primary table element stores a plurality of query positions that a w-mer maps to up to a specified limit. Preferably, this limit is three query positions. Since a w-mer may map to more than three positions in the query sequence, the primary table entry 910 and 912 is extended to hold a duplicate bit 920. If the duplicate bit is set, the remaining bits in the entry hold a duplicate table pointer 924 and an entry count value 922. Duplicate query positions are stored in consecutive memory locations 900 in the duplicate table 908, starting at the address indicated by the duplicate pointer 924. The number of duplicates for each w-mer is limited by the size of the count field 922, and the amount of off-chip memory available.

Lookups into the duplicate table 908 reduce the throughput of the word matching stage 108. It is highly desirable for such lookups be kept to a minimum, such that most w-mer lookups are satisfied by a single probe into the primary table 906. It is expected that the word matching stage 108 will generate approximately two query positions per w-mer lookup, when used with the default parameters. To decrease the number of SRAM probes for each w-mer, the 11-bit query positions are preferably packed three in each primary table entry. To achieve this packing in the 31 bits available in the 32-bit SRAM, it is preferred that a modular delta encoding scheme be employed. Modular delta encoding can be defined as representing a plurality of query positions by defining one query position with a base reference for that position in the query sequence and then using a plurality of modulo offsets that define the remaining actual query positions when combined with the base reference. The conditions under which such modular delta encoding is particularly advantageous can be defined as:
G+(G−1)(n−1)≦W−1 and
Gn>W−1
Wherein W represents the bit width of the lookup table entries, wherein G represents the number of bits needed to represent a full query position, and wherein n represents the maximum limit for storing query positions in a single lookup table entry.

With modular delta encoding, a first query position (qp₀) 914 for a given w-mer is stored in the first 11 bits, followed by two unsigned 10-bit offset values 916 and 918 (qo₁ and qo₂). The three query positions for hits H₁, H₂ and H₃ (wherein Hᵢ=(qᵢ, dᵢ) can then be decoded as follows:
q₁=qp₀
q₂=(qp₀+qo₁)mod 2048
q₃=(qp₀+qo₁+qo₂)mod 2048
The result of each modulo addition for q₂ and q₃ will be an 11-bit query position. Thus, the pointers 914, 916 and 918 stored in the lookup table serve as position identifiers for identifying where in the query sequence a hit with the current database w-mer is found.

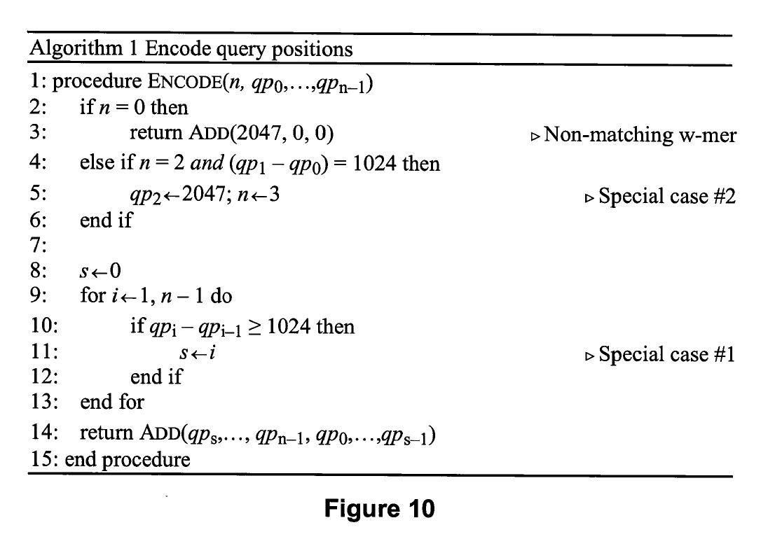

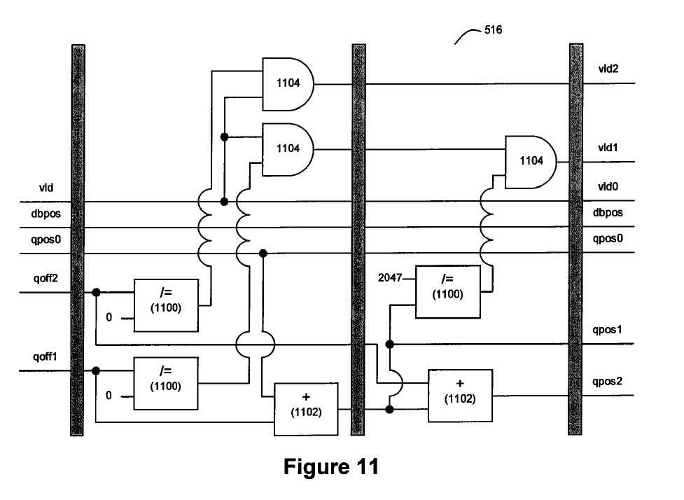

Preferably, the encoding of the query positions in the lookup table is performed during the pre-processing step on the host CPU using the algorithm shown in FIG. 10. There are two special cases that should be handled by the modular delta encoding algorithm of FIG. 10. Firstly, for three or more sorted query positions, 10 bits are sufficient to represent the difference between all but (possibly) one pair of query positions (qpᵢ, qpⱼ), wherein the following conditions are met:
qpⱼ−qpᵢ>2^{G-1} and
qpⱼ>qpᵢ
The solution to this exception is to start the encoding by storing qpⱼ in the first G bits 914 of the table entry (wherein G is 11 bits in the preferred embodiment). For example, query positions 10, 90, and 2000 can be encoded as (2000, 58, 80). Secondly, if there are only two query positions, with a difference of exactly 1024, a dummy value of 2047 is introduced, after which the solution to the first case applies. For example, query positions 70 and 1094 are encoded as (1094, 953, 71). Query position 2047 is recognized as a special case and ignored in the hit compute module 516 (as shown in FIG. 11). This dummy value of 2047 can be used without loss of information because query w-mer positions only range from [0 . . . 2047−w].

As a result of the encoding scheme used, query positions may be retrieved out of order by the word matching module. This, however, is of no consequence to the downstream stages, since the hits remain sorted by database position.

TABLE 2
SRAM Access Statistics in the Word Matching
Module, for a Neighborhood of N(4, 13)
% of DB w-mers satisfied

| SRAM probes | Offset-encoded | Naïve |
|---|---|---|
| 1 | 82.6158 | 67.5121 |
| 2 | 82.6158 | 67.5121 |
| 3 | 98.0941 | 91.3216 |
| 4 | 99.8407 | 98.0941 |
| 5 | 99.9889 | 99.6233 |
| 6 | 100.0000 | 99.9347 |
| 7 | 100.0000 | 99.9889 |
| 8 | 100.0000 | 99.9985 |
| 9 | 100.0000 | 100.000 |

Table 2 reveals the effect of the modular delta encoding scheme for the query sequence on the SRAM access pattern in the word matching stage. The table displays the percentage fᵢ of database w-mer lookups that are satisfied in aᵢ or fewer probes into the SRAM. The data is averaged for a neighborhood of N(4,13), over BLASTP searches of twenty 2048-residue query sequences compiled from the Escherichia coli k12 proteome, against the NR database. It should be noted that 82% of the w-mer lookups can be satisfied in a single probe when using the modular delta encoded lookup table (in which a single probe is capable of returning up to three query positions). The naïve scheme (in which a single probe is capable of returning only two query positions) would satisfy only 67% of lookups with a single probe, thus reducing the overall throughput.

Note, in case that the duplicate bit is set, the first probe returns the duplicate table address (and zero query positions). Table 2 also indicates that all fifteen query positions are retrieved in 6 SRAM accesses when the encoding scheme is used; this increases to 9 otherwise in the naïve scheme.

Thus, with reference to FIG. 9, as a database w-mer 904 (or a key 904 produced by base conversion unit 510 from the database w-mer) is received by the table lookup unit 512, the entry stored in the SRAM lookup table entry located at an address equal to w-mer/key 904 is retrieved. If the duplicate bit is not set, then the entry will be as shown for entry 910 with one or more modular delta encoded query position identifiers 914, 916 and 918 as described above. If the duplicate bit is set, then duplicate pointer 924 is processed to identify the address in the duplicate table 908 where the multiple query position identifiers are stored. Count value 922 is indicative of how many query position identifiers are hits on the database w-mer. Preferably, the entries 900 in the duplicate table for the hits to the same database w-mer are stored in consecutive addresses of the duplicate table, to thereby allow efficient retrieval of all pertinent query position identifiers using the count value. The form of the duplicate table entry 900 preferably mirrors that of entry 914 in the primary table 906.

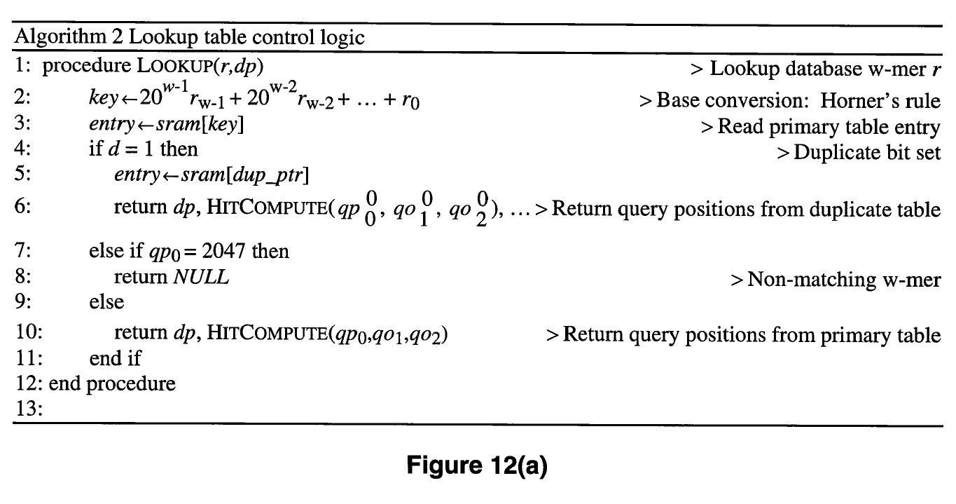

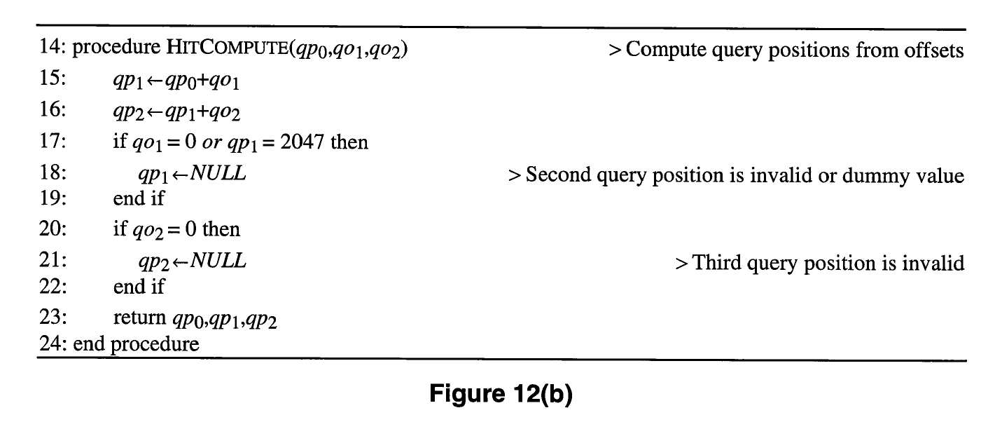

Decoding the query positions in hardware is done in the hit compute module 516. The two stage pipeline 516 is depicted in FIG. 11 and the control logic realized by the hardware pipeline of FIG. 11 is shown in FIGS. 12(a) and 12(b). The circuit 516 accepts a database position dbpos, a query position qp₀, and up to two query offsets qo₁ and qo₂. Two back-to-back adders 1102 generate q₂ and q₃. Each query offset represents a valid position if it is non-zero (as shown by logic 1100 and 1104). Additionally, the dummy query position of 2047 is discarded (as shown by logic 1100 and 1104). The circuit 516 preferably outputs up to three hits at the same database position.

1.B. Hit Filtering Module 110

Another component in the seed generation pipeline is the hit filtering module 110. As noted above, only a subset of the hits found in the hit stream produced by the word matching module are likely to be significant. The BLASTN heuristic and the initial version of BLASTP heuristic consider each hit in isolation. In such a one-hit approach, a single hit is considered sufficient evidence of the presence an HSP and is used to trigger a seed for delivery to the ungapped extension stage. A neighborhood N(4, 17) may be used to yield sufficient hits to detect similarity between typical protein sequences. A large number of these seeds, however, are spurious and must be filtered by expensive seed extension, unless an alternative solution is implemented.

Thus, to reduce the likelihood of spurious hits being passed on to the more intensive ungapped extension stage of BLASTP processing, a hit filtering module 110 is preferably employed in the seed generation stage. To pass the hit filtering module 110, a hit must be determined to be sufficiently close to another hit in the database biosequence. As a preferred embodiment, the hit filtering module 110 may be implemented as a two hit module described hereinafter.

The two-hit refinement is based on the observation that HSPs of biological interest are typically much longer than a word. Hence, there is a high likelihood of generating multiple hits in a single HSP. In the two-hit method, hits generated by the word matching module are not passed directly to ungapped extension; instead they are recorded in memory that is representative of a diagonal array. The presence of two hits in close proximity on the same diagonal (noting that there is a unique diagonal associated with any HSP that does not include gaps) is the necessary condition to trigger a seed. Upon encountering a hit (q, d) in the word matching stage, its offset in the database sequence is recorded on the diagonal D=d−q. A seed is generated when a second non-overlapping hit (q′, d′) is detected on the same diagonal within a window length of A residues, i.e. d′−q′=d−q and d′−d<A. The reduced seed generation rate provided by this technique improves filtering efficiency, drastically reducing time spent in later stages.

In order to attain comparable sensitivity to the one-hit algorithm, a more permissive neighborhood of N(3, 11) can be used. Although this increases the number of hits generated by the word matching stage, only a fraction pass as seeds for ungapped extension. Since far less time is spent filtering hits than extending them, there is a significant savings in the computational cost.

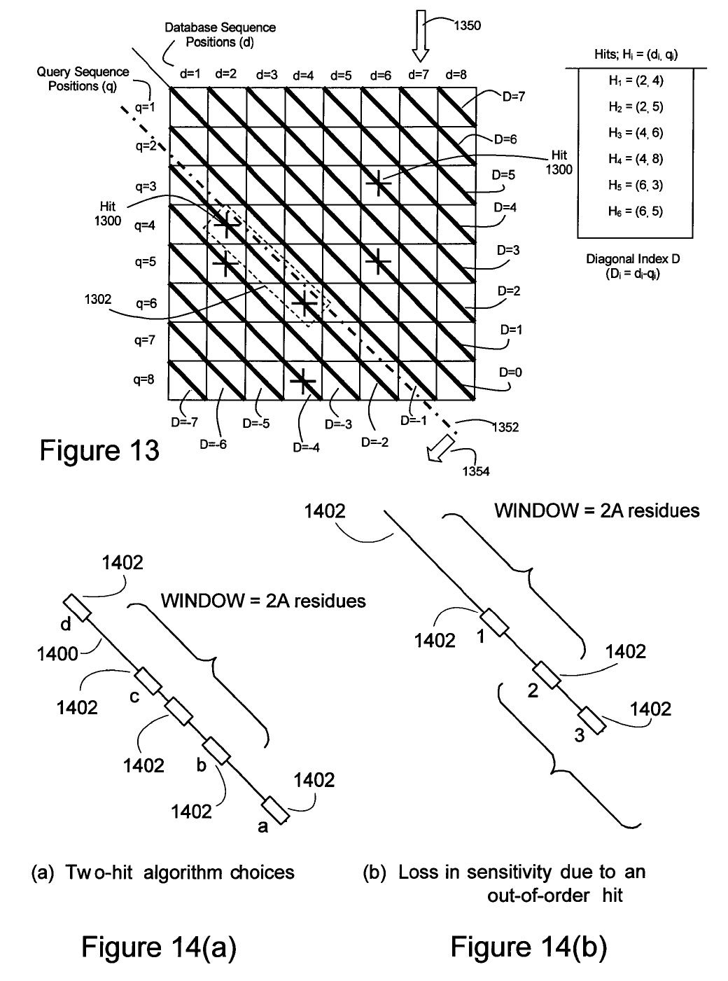

FIG. 13 illustrates the two-hit concept. FIG. 13 depicts a conceptual diagonal array as a grid wherein the rows correspond to query sequence positions (q) of a hit and wherein the columns correspond to database sequence positions (d) of a hit. Within this grid, a plurality of diagonals indices D can be defined, wherein each diagonal index D equals dⱼ−qᵢ for all values of i and j wherein i=j, as shown in FIG. 13. FIG. 13 depicts how 6 hits (H₁ through H₆) would map to this grid (see hits 1300 in the grid). Of these hits, only the hits enclosed by box 1302 map to the same diagonal (the diagonal index for these two hits is D=−2). The two hits on the diagonal having an index value of −2 are separated by two positions in the database sequence. If the value of A is greater than or equal to 2, then either (or both) of the two hits can be passed as a seed to the ungapped extension stage. Preferably, the hit with the greater database sequence position is the one forwarded to the ungapped extension stage.

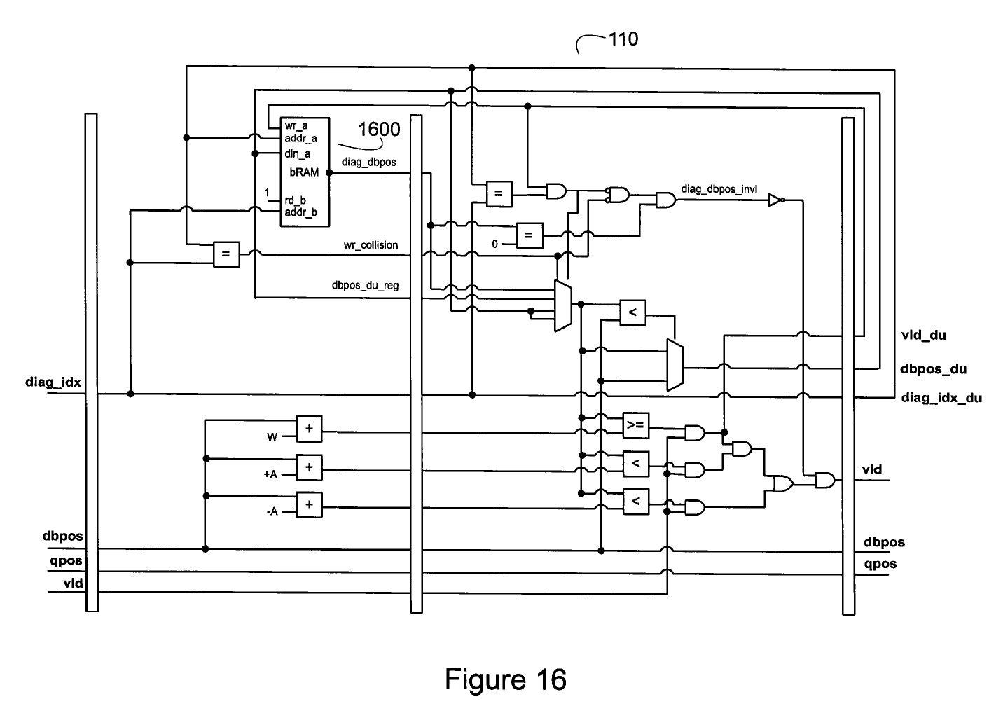

The algorithm conceptually illustrated by FIG. 13 can be efficiently implemented using a data structure to store the database positions of seeds encountered on each diagonal. The diagonal array is preferably implemented using on-chip block RAMs 1600 (as shown in FIG. 16) of size equal to 2M, where M is the size (or residue length) of the query sequence. As the database is scanned left to right, all diagonals Dₖ<dₖ−M are no longer used and may be discarded. That is, if the current database position is d=7, as denoted by arrow 1350 in FIG. 13, then it should be noted that the diagonals D≦−2 need not be considered because they will not have any hits that share a diagonal with a hit whose database position is d=7. The demarcation between currently active diagonals and no longer active diagonals is represented conceptually in FIG. 13 by dashed line 1352. It should be noted that a similar distinction between active and inactive diagonals can be made in the forward direction using the same concept. It is also worth noting that given the possibility that some hits will arrive out of order at the two hit module with respect to their database position, it may be desirable to retain some subset of the older diagonals to allow for successful two-hit detection even when a hit arrives out of order with respect to its database position. As explained herein, the inventors believe that a cushion of approximately 40 to 50 additional diagonals is effective to accommodate most out of order hit situations. Such a cushion can be conceptually depicted by moving line 1352 in the direction indicated by arrow 1354 to define the boundary at which older diagonals become inactive. Dᵢ indexes the array and wraps around to reuse memory locations corresponding to discarded diagonals. For a query size of 2048 and 32-bit database positions, the diagonal array can be implemented in eight block RAMs 1600.

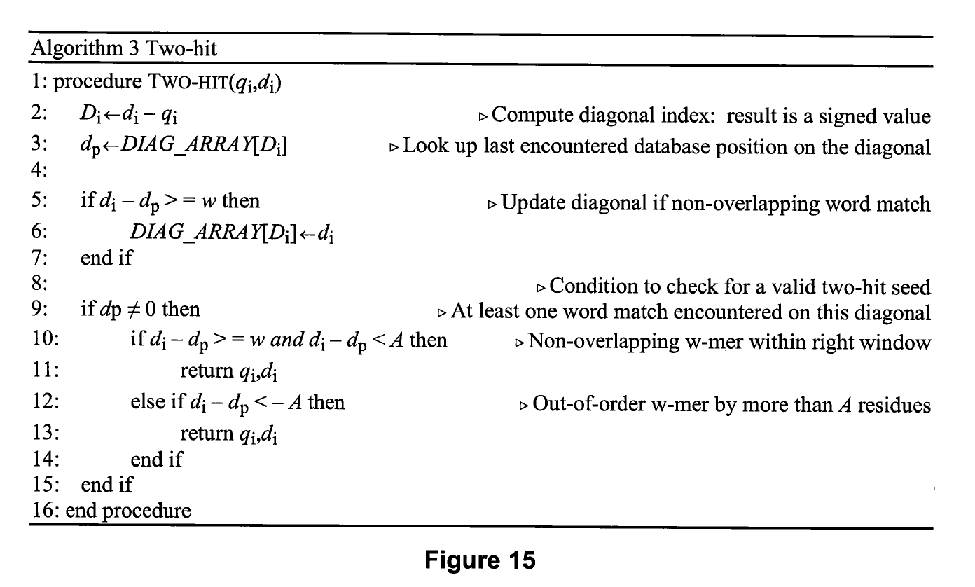

FIG. 15 depicts a preferred two-hit algorithm. Line 9 of the algorithm ensures that at least one word match has been encountered on the diagonal, before generating a seed. This can be accomplished by checking for the initial zero value (database positions range from 1 . . . N). A valid seed is generated if the word match does not overlap and is within A residues to the right of the last encountered w-mer (see Line 10 of the algorithm). Finally, the latest hit encountered is recorded in the diagonal array, at Line 5 of the algorithm.

As described below, the two-hit module is preferably capable of handling hits that are received out of order (with respect to database position), without an appreciable loss in sensitivity or an appreciable increase in the workload of downstream stages. To address this “out of order” issue, the algorithm of FIG. 15 (see Line 12) performs one of the following: if the hit is within A residues to the left of the last recorded hit, then that hit is discarded; otherwise, that hit is forwarded it to the next stage as a seed. In the former case (the discarded hit), the out-of-order hit is likely part of an HSP that was already inspected—assuming the last recorded hit was passed for ungapped extension—and can be safely ignored. In practice, for A=40, most out-of-order hits are expected to fall into this category (due to design and implementation parameters).

FIG. 14(a) shows the choices for two-hit computation on a single diagonal 1400, upon the arrival of a second hit relative to a first hit (depicted as the un-lettered hit 1402; the diagonal 1400 having a number of hits 1402 thereon). If the second hit is within the window rightward from the base hit (hit b), then hit b is forwarded to the next stage; if instead the second hit is beyond A residues rightward from the base hit (hit a), then hit a is discarded. An out-of-order hit (hit c) within the left window of the base hit is discarded, while hit d, which is beyond A residues, is passed on for ungapped extension. This heuristic to handle out-of-order hits may lead to false negatives. FIG. 14(b) illustrates this point, showing three hits numbered in their order of arrival. When hit 2 arrives, it is beyond the right window of hit 1 and is discarded. Similarly, hit 3 is found to be in the left window of hit 2 and discarded. A correct implementation would forward both hits 2 and 3 for extension. The out of order heuristic employed by the two-hit algorithm, though not perfect, handles out-of-order hits without increasing the workload of downstream stages. The effect on sensitivity was empirically determined to be negligible.

FIG. 16 illustrates the two-hit module 110 deployed as a pipeline in hardware. An input hit (dbpos, qpos) is passed in along with its corresponding diagonal index, diag_idx. The hit is checked in the two-hit logic, and sent downstream (i.e. vld is high) if it passes the two-hit tests. The two-hit logic is pipelined into three stages to enable a high-speed design. This increases the complexity of the two-hit module since data has to be forwarded from the later stages. The Diagonal Read stage performs a lookup into the block RAM 1600 using the computed diagonal index. The read operation uses the second port of the block RAM 1600 and has a latency of one clock cycle. The first port is used to update a diagonal with the last encountered hit in the Diagonal Update stage. A write collision condition is detected upon a simultaneous read/write to the same diagonal, and the most recent hit is forwarded to the next stage. The second stage performs the Two-hit Check and implements the three conditions discussed above. The most recent hit in a diagonal is selected from one of three cases: a hit from the previous clock cycle (forwarded from the Diagonal Update stage), a hit from the last but one clock cycle (detected by the write collision check), or the value read from the block RAM 1600. The two-hit condition checks are decomposed into two stages to decrease the length of the critical path, e.g: dᵢ−dₚ<A becomes tmp=dᵢ−A and tmp<dₚ. A seed is generated when the requisite conditions are satisfied.

NCBI BLASTP employs a redundancy filter to discard seeds present in the vicinity of HSPs inspected in the ungapped extension stage. The furthest database position examined after extension is recorded in a structure similar to the diagonal array. In addition to passing the two-hit check, a hit must be non-overlapping with this region to be forwarded to the next stage. This feedback characteristic of the redundancy filter for BLASTP (wherein the redundancy filter requires feedback from the ungapped extension stage) makes it a questionable as to its value in a hardware implementation.

TABLE 3
Increase in Seed Generation Rate without
Feedback from NCBI BLASTP Stage 2

| Query Length | | Rate Increase |
|---|---|---|
| (residues) | N(w, T) | (%) |
| 2000 | N(3, 11) | 0.2191 |
| 2000 | N(4, 13) | 0.2246 |
| 2000 | N(5, 14) | 0.2784 |
| 3000 | N(3, 11) | 0.2222 |
| 3000 | N(4, 13) | 0.2205 |
| 3000 | N(5, 14) | 0.2743 |
| 4000 | N(3, 11) | 0.2359 |
| 4000 | N(4, 13) | 0.2838 |
| 4000 | N(5, 14) | 0.3956 |

The inventors herein measured the effect of the lack of the NCBI BLASTP extension feedback on the seed generation rate of the first stage. Table 3 shows the increased seed generation rate for various query sizes and neighborhoods. The data of Table 3 suggests a modest increase in workload for ungapped extension, of less than a quarter of one percent. The reason for this minimal increase in workload is that the two-hit algorithm is already an excellent filter, approximately performing the role of the redundancy filter. Based on this data, the inventors conclude that feedback from stage 2 has little effect on system throughput and prefer to not include a redundancy filter in the BLASTP pipeline. However, it should be noted that a practitioner of the present invention may nevertheless choose to include such a redundancy filter.

### 1.C. Module Replication for Higher Throughput

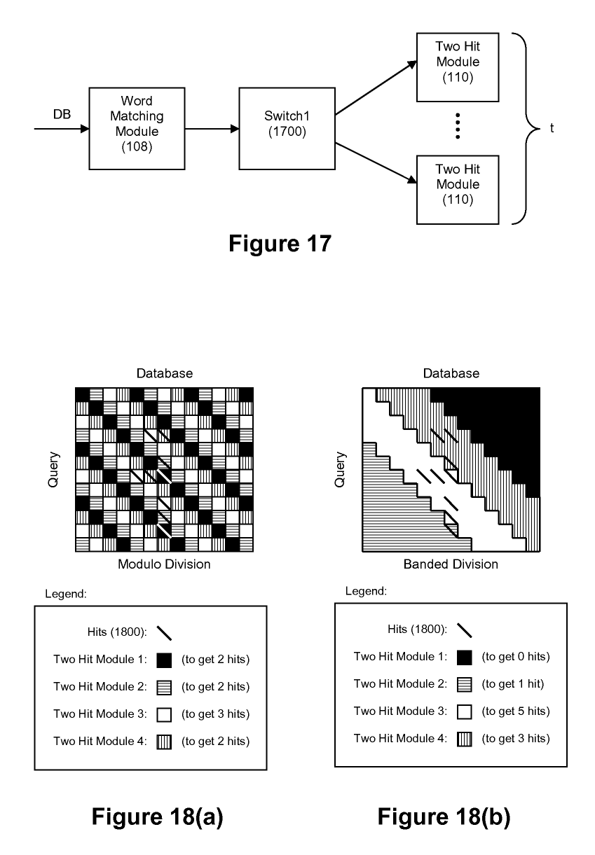

As previously noted, the word matching module 108 can be expected to generate hits at the rate of approximately two per database sequence position for a neighborhood of N(4, 13). The two-hit module 110, with the capacity to process only a single hit per clock cycle, then becomes the bottleneck in the pipeline. Processing multiple hits per clock cycle for the two-hit module, however, poses a substantial challenge due to the physical constraints of the implementation. Concurrent access to the diagonal array is limited by the dual-ported block RAMs 1600 on the FPGA. Since one port is used to read a diagonal and the other to update it, no more than one hit can be processed in the two-hit module at a time. In order to address this issue, the hit filtering module (preferably embodied as a two-hit module) is preferably replicated in multiple parallel hit filtering modules to process hits simultaneously. Preferably, for load balancing purposes, hits are relatively evenly distributed among the copies of the hit filtering module. FIG. 17 depicts an exemplary pipeline wherein the hit filtering module 110 is replicated for parallel processing of a hit stream. To distribute hits from the word matching module 108 to an appropriate one of the hit filtering modules 110, a switch 1700 is preferably deployed in hardware in the pipeline. As described below, switch 1700 preferably employs a modulo division routing scheme to decide which hits should be sent to which hit filtering module.

A straightforward replication of the entire diagonal array would require that all copies of the diagonal array be kept coherent, leading to a multi-cycle update phase and a corresponding loss in throughput. Efforts to time-multiplex access to block RAMs (for example, quad-porting by running them at twice the clock speed of the two-hit logic) can be used, although such a technique is less than optimal and in some instances may be impractical because the two-hit logic already runs at a high clock speed.

The inventors herein note that the two-hit computation for a w-mer is performed on a single diagonal and the assessment by the two hit module as to whether a hit is maintained is independent of the values of all other diagonals. Rather than replicating the entire diagonal array, the diagonals can instead be evenly divided among b two-hit modules. A hit (qᵢ, dᵢ) is processed by the j^{th} two-hit copy if Dᵢ mod b=j−1. This modulo division scheme also increases the probability of equal work distribution between the b copies.

While a banded division of diagonals to two hit module copies can be used (e.g., diagonals 1-4 are assigned to a first two hit module, diagonals 5-8 are assigned to a second two hit module, and so on), it should be noted that hits generated by the word matching phase tend to be clustered around a few high scoring residues. Hence, a banded division of the diagonal array into b bands may likely lead to an uneven partitioning of hits, as shown in FIGS. 18(a) and (b). FIG. 18(a) depicts the allocation of hits 1800 to four two-hit modules for a modulo division routing scheme, while FIG. 18(b) depicts an allocation of hits 1800 to four two-hit modules for a banded division routing scheme. The hits are shown along their corresponding diagonal indices, with each diagonal index being color coded to represent one of the four two hit module to which that diagonal index has been assigned. As shown in FIG. 18(b), most of the workload has been delivered to only two of the four two hit modules (the ones adjacent to the zero diagonal) while the other two hit modules are left largely idle. FIG. 18(a), however, indicates how modulo division routing can provide a better distribution of the hit workload.

With a modulo division routing scheme, the routing of a hit to its appropriate two-hit module is also simplified. If b is a power of two, i.e. b=2^{t}, the lower t bits of Dᵢ act as the identifier for the appropriate two hit module to serve as the destination for hit Hᵢ. If not b is not a power of 2, the modulo division operation can be pre-computed for all possible Dᵢ values and stored in on-chip lookup tables.

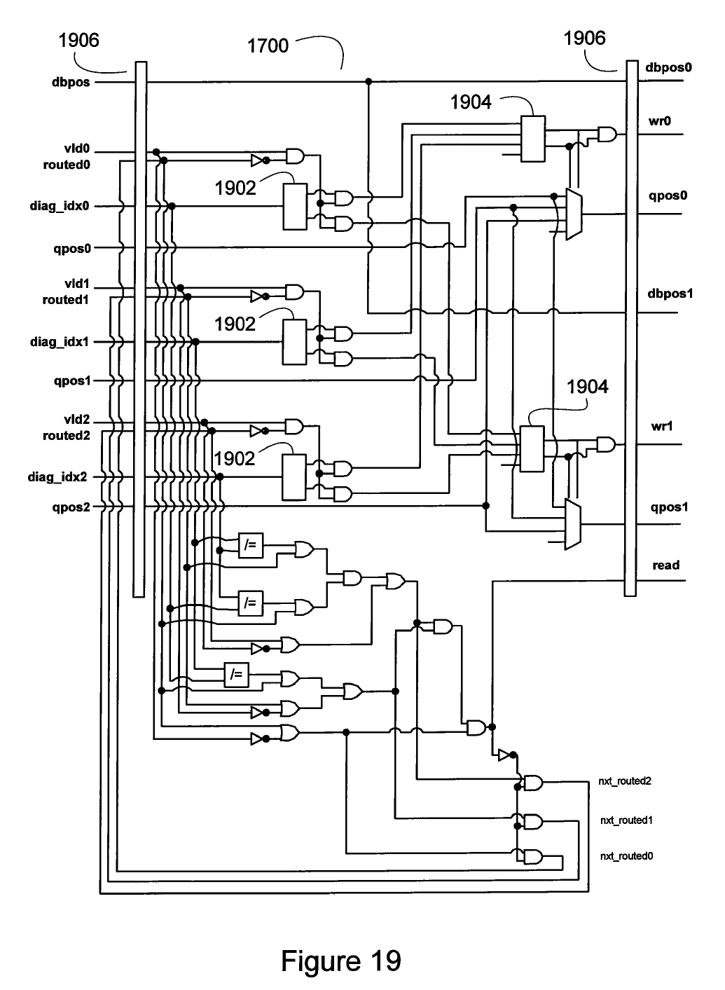

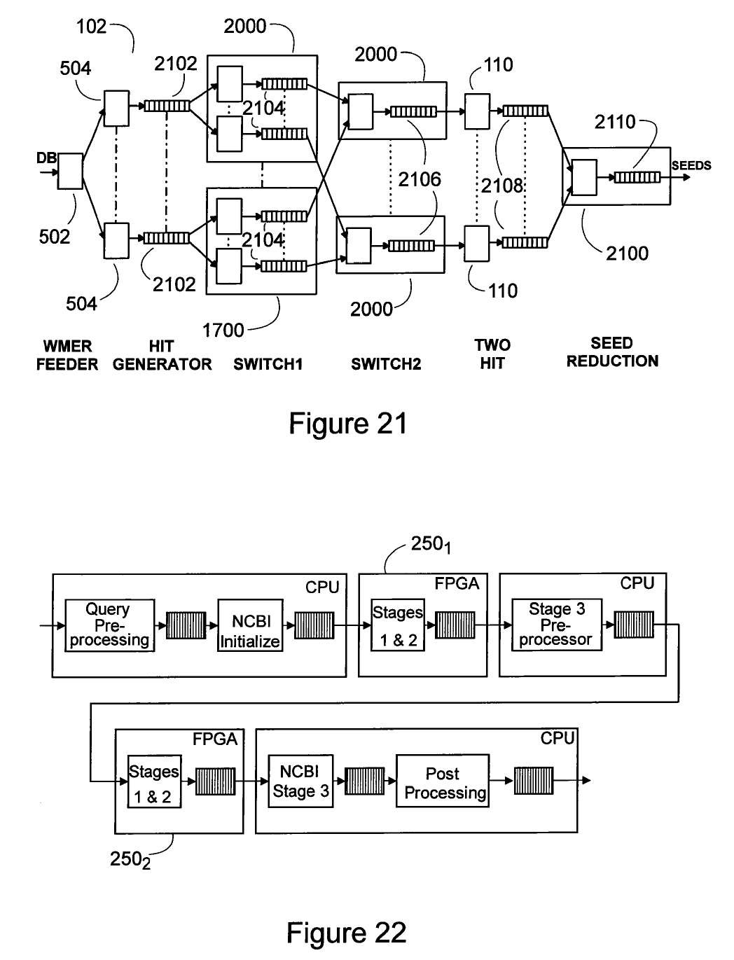

FIG. 19 displays a preferred hardware design of the 3×b interconnecting switch 1700 (Switch 1) that is disposed between a single word matching stage 108 and b=2 two-hit modules 110. The word matching module 108 generates up to three hits per clock cycle (dbpos, qpos₀, diag_idx₀, vld₀, . . . ), which are stored in a single entry of an interconnecting FIFO 2102 (as shown in FIG. 21). All hits in a FIFO entry share the same database position and must be routed to their appropriate two-hit modules before the next triple can be processed. The routing decision is made independently, in parallel, and locally at each switch 1700. Hits sent to the two-hit modules are (dbpos₀, qpos₀) and (dbpos₁, qpos₁).

A decoder 1902 for each hit examines t low-order bits of the diagonal index (wherein t=1, when b is 2 given that b=2^{t}). The decoded signal is passed to a priority encoder 1904 at each two-hit module to select one of the three hits. In case of a collision, priority is given to the higher-ordered hit. Information on whether a hit has been routed is stored in a register 1906 and is used to deselect a hit that has already been sent to its two-hit module. This decision is made by examining if the hit is valid, is being routed to a two-hit unit that is not busy, or has already been routed previously. The read signal is asserted once the entire triple has been routed. Each two-hit module can thus accept at least one available hit every clock cycle. With the word matching module 108 generating two hits on average per clock cycle, b=2 two-hit modules are likely to be sufficient to eliminate the bottleneck from this phase. However, it should be noted that other values for b can be used in the practice of this aspect of the invention.

With downstream stages capable of handling the seed generation rate of the first stage 102, the throughput of the BLASTP pipeline 100 is thus limited by the word matching module 108, wherein the throughput of the word matching module 108 is constrained by the lookup into off-chip SRAM 514. One solution to speed up the pipeline 100 is to run multiple hit generation modules 504 in parallel, each accessing an independent off-chip SRAM resource 514 with its own copy of the lookup table. Adjacent database w-mers are distributed by the feeder stage 502 to each of h hit generation modules 504. The w-mer feeder 502 preferably employs a round robin scheme to distribute database w-mers among hit generators 504 that are available for that clock cycle. Each hit generator 504 preferably has its own independent backpressure signal for assertion when that hit generator is not ready to receive a database w-mer. However, it should be noted that distribution techniques other than round robin can be used to distribute database w-mers among the hit generators. Hits generated by each copy of the hit generator 504 are then destined for the two-hit modules 110. It should be noted that the number of two-hit modules should be increased to keep up with the larger hit generation rate (e.g., the number of parallel two hit modules in the pipeline is preferably b*h)

The use of h independent hit generator modules 504 has an unintended consequence on the generated hit stream. The w-mer processing time within each hit generator 504 is variable due to the possibility of duplicate query positions. This characteristic causes the different hit generators 504 to lose synchronization with each other and generate hits that are out of order with respect to the database positions. Out-of-order hits may be discarded in the hardware stages. This however, leads to decreased search sensitivity. Alternatively, hits that are out of order by more than a fixed window of database residues in the extension stages may be forwarded to the host CPU without inspection. This increases the false positive rate and has an adverse effect on the throughput of the pipeline.

This problem may be tackled in one of three ways. First, the h hit generator modules 504 may be deliberately kept synchronized. On encountering a duplicate, every hit generator module 504 can be controlled to pause until all duplicates are retrieved, before the next set of w-mers is accepted. This approach quickly degrades in performance: as h grows, the probability of the modules pausing increases, and the throughput decreases drastically. A second approach is to pause the hit generator modules 504 only if they get out of order by more than a downstream tolerance. A preferred third solution is slightly different. The number of duplicates for each w-mer in the lookup table 514 is limited to L, requiring a maximum processing time of 1=┌L/3┐ clock cycles in a preferred implementation. This automatically limits the distance the hits can get out of order in the worst case to (dₜ+1)×(h−1) database residues, without the use of additional hardware circuitry. Here, dₜ is the latency of access into the duplicate table. The downstream stages can then be designed for this out-of-order tolerance level. In such a preferred implementation, dₜ can be 4 and L can be 15. The loss in sensitivity due to the pruning of hits outside this window was experimentally determined to be negligible.

With the addition of multiple hit generation modules 504, additional switching circuitry can be used to route all h hit triples to their corresponding two-hit modules 110. Such a switch essentially serves as a buffered multiplexer and can also be referred to as Switch2 (wherein switch 1700 is referred to as Switch1). The switching functions of Switch2 can be achieved in two phases. Firstly, a triple from each hit generation module 504 is routed to b queues 2104 (one for each copy of the two-hit module), using the interconnecting Switch1 (1700). A total of h×b queues, each containing a single hit per entry, are generated. Finally, a new interconnecting switch (Switch2) is deployed upstream from each two-hit module 110 to select hits from one of h queues. This two-phase switching mechanism successfully routes any one of 3×h hits generated by the word matching stage to any one of the b two-hit modules.

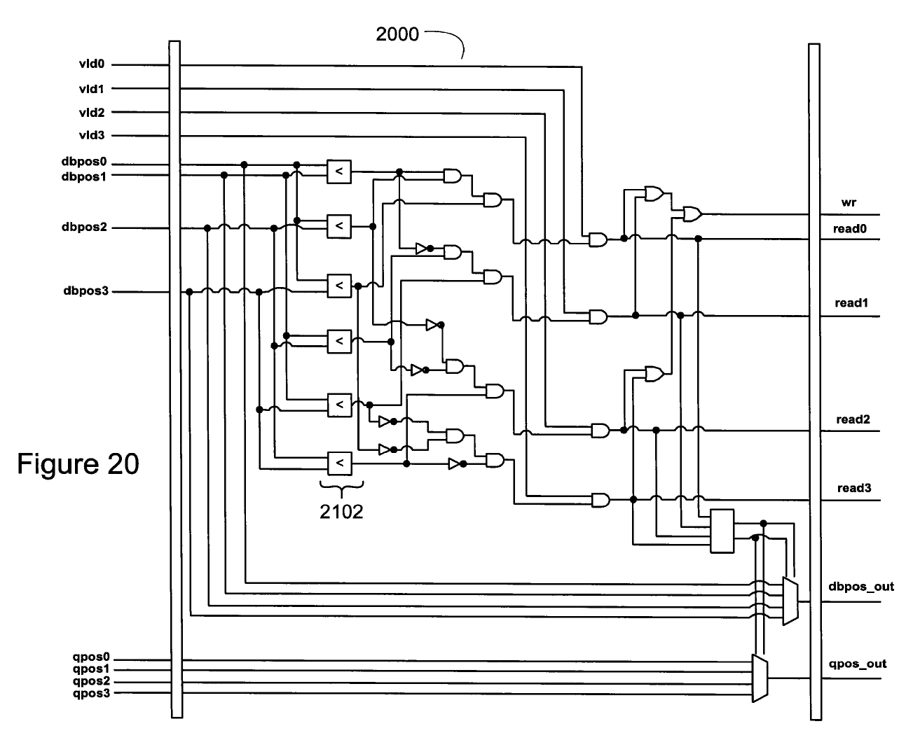

FIG. 20 depicts a preferred the single stage hardware design of the buffered multiplexer switch 2000, with h=4. Hits (dbpos₀, qpos₀, . . . ) each with a valid signal, must be routed to a single output port (dbposₒᵤₜ, qposₒᵤₜ). The buffered multiplexer switch 2000 is designed to not introduce out-of-order hits and impose a re-ordering of hits by database position via a comparison tree 2102 which sorts from among a plurality of incoming hits (e.g., from among four incoming hits) to forward the hit with the lowest database position. Parallel comparators (that are (h×(h−1))/2 in number) within the comparison tree 2102 inspect the first element of all h queues to detect the hit at the lowest database position. This hit is then passed directly to the two-hit module 110 and cleared from the input queue.

Thus, FIG. 21 illustrates a preferred architecture for the seed generation stage 102 using replication of the hit generator 504 and two hit module 110 to achieve higher throughput. The w-mer feeder block 502 accepts the database stream from the host CPU, generating up to h w-mers per clock. Hit triples in queues 2102 from the hit generator modules 504 are routed to one of b queues 2104 in each of the h switch 1 circuits 1700. Each buffered multiplexer switch 2000 then reduces the h input streams to a single stream and feeds its corresponding two-hit module 110 via queue 2106.

A final piece of the high throughput seed generation pipeline depicted in FIG. 21 comprises a seed reduction module 2100. Seeds generated from b copies of the two-hit modules 110 are reduced to a single stream by the seed reduction module 2100 and forwarded to the ungapped extension phase via queue 2110. An attempt is again made by the seed reduction module 2100 to maintain an order of hits sorted by database position. The hardware circuit for the seed reduction module 2100 is preferably identical to the buffered multiplexer switch 2000 of FIG. 20, except that a reduction tree is used. For a large number of input queues (>4), the single-stage design described earlier for switch 2000 has difficulty routing at high clock speeds. For b=8 or more, the reduction of module 2100 is preferably performed in two stages: two 4-to-1 stages followed by a single 2-to-1 stage. It should also be noted that the seed reduction module 2100 need not operate as fast the rest of the seed generation stage modules because the two hit modules will likely operate to generate seeds at a rate of less than one per clock cycle.

Further still, it should be noted that a plurality of parallel ungapped extension analysis stage circuits as described hereinafter can be deployed downstream from the output queues 2108 for the multiple two hit modules 110. Each ungapped extension analysis circuit can be configured to receive hits from one or more two hit modules 110 through queues 2108. In such an embodiment, the seed reduction module 2100 could be eliminated.

Preferred instantiation parameters for the seed generation stage 102 of FIG. 21 are as follows. The seed generation stage preferably supports a query sequence of up to 2048 residues, and uses a neighborhood of N(4, 13). A database sequence of up to 232 residues is also preferably supported. Preferably, h=3 parallel copies of the hit generation modules 504 are used and b=8 parallel copies of the two-hit modules 110 are used.

A dual-FPGA solution is used in a preferred embodiment of a BLASTP pipeline, with seed generation and ungapped extension deployed on the first FPGA and gapped extension running on the second FPGA, as shown in FIG. 22. The database sequence is streamed from the host CPU to the first card 250₁. HSPs generated after ungapped extension are sent back to the host CPU, where they are interleaved with the database sequence and resent to the gapped extension stage on the second card 2502. Significant hits are then sent back to the host CPU to resume the software pipeline.

Data flowing into and out of a board 250 is preferably communicated along a single 64-bit data path having two logic channels—one for data and the other for commands. Data flowing between stages on the same board or same reconfigurable logic device may utilize separate 64-bit data and control buses. For example, the data flow between stage 108 and stage 110 may utilize separate 64-bit data and control buses if those two stages are deployed on the same board 250. Module-specific commands program the lookup tables 514 and clear the diagonal array 1600 in the two-hit modules. The seed generation and ungapped extension modules preferably communicate via two independent data paths. The standard data communication channel is used to send seed hits, while a new bus is used to stream the database sequence. All modules preferably respect backpressure signals asserted to halt an upstream stage when busy.

### 2. Ungapped Extension Stage 104

The architecture for the ungapped extension stage 104 of the BLASTP is preferably the same as the ungapped extension stage architecture disclosed in the incorporated Ser. No. 11/359,285 patent application for BLASTN, albeit with a different scoring technique and some additional buffering (and associated control logic) used to accommodate the increased number of bits needed to represent protein residues (as opposed to DNA bases).

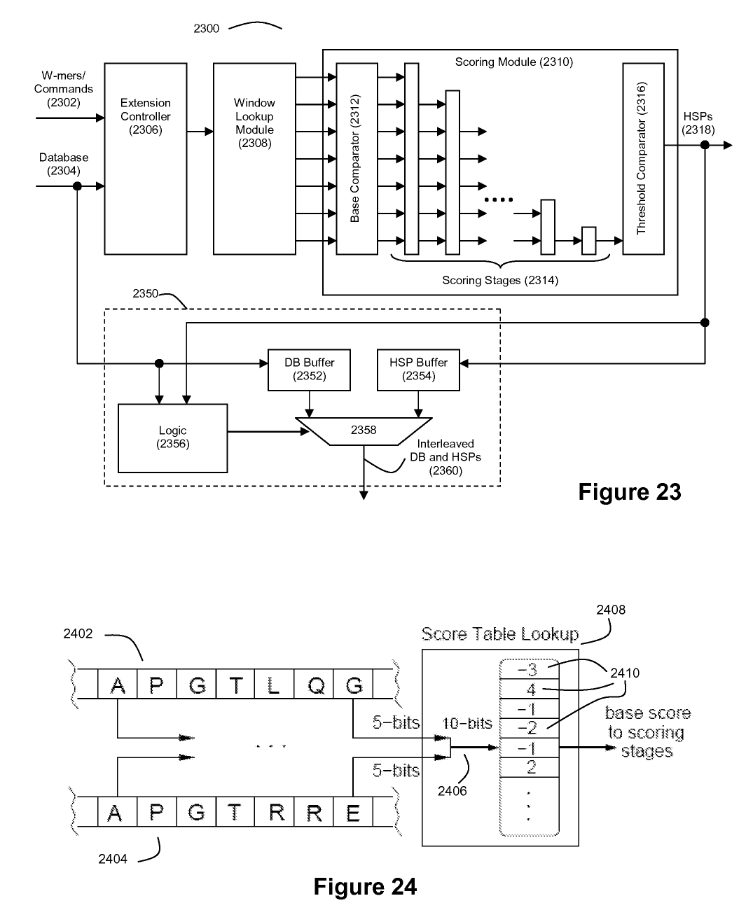

As disclosed in the incorporated Ser. No. 11/359,285 patent application, the ungapped extension stage 104 can be realized as a filter circuit 2300 such as shown in FIG. 23. With circuit 2300, two independent data paths can be used for input into the ungapped extension stage; the w-mers/commands and the data which is parsed with the w-mers/commands are received on path 2302, and the data from the database is received on path 2304.

The circuit 2300 is preferably organized into three (3) pipelined stages. This includes an extension controller 2306, a window lookup module 2308, and a scoring module 2310. The extension controller 2306 is preferably configured to parse the input to demultiplex the shared w-mers/commands 2302 and database stream 2304. All w-mer matches and the database stream flow through the extension controller 2306 into the window lookup module 2308. The window lookup module 2308 is responsible for fetching the appropriate substrings of the database stream and the query to form an alignment window. A preferred embodiment of the window lookup module also employs a shifting-tree to appropriately align the data retrieved from the buffers.

After the window is fetched, it is passed into the scoring module 2310 and stored in registers. The scoring module 2310 is preferably extensively pipelined as shown in FIG. 13. The first stage of the scoring pipeline 2310 comprises a base comparator 2312 which receives every base pair in parallel registers. Following the base comparator 2312 are a plurality of successive scoring stages 2314, as described in the incorporated Ser. No. 11/359,285 patent application. The scoring module 2310 is preferably, but not necessarily, arranged as a classic systolic array. Alternatively, the scoring module may also be implemented using a comparison tree. The data from a previous stage 2314 are read on each clock pulse and results are output to the following stage 2314 on the next clock pulse. Storage for comparison scores in successive pipeline stages 2314 decrease in every successive stage, as shown in FIG. 23. This decrease is possible because the comparison score for window position “i” is consumed in the ith pipeline stage and may then be discarded, since later stages inspect only window positions that are greater than i.

The final pipeline stage of the scoring module 2310 is the threshold comparator 2316. The comparator 2316 takes the fully-scored segment and makes a decision to discard or keep the segment. This decision is based on the score of the alignment relative to a user-defined threshold T, as well as the position of the highest-scoring substring. If the maximum score is above the threshold, the segment is passed on. Additionally, if the maximal scoring substring intersects either boundary of the window, the segment is also passed on, regardless of the score. If neither condition holds, the substring of a predetermined length, i.e., segment, is discarded. The segments that are passed on are indicated as HSPs 2318 in FIG. 23.

As indicated above, when configured as a BLASTP ungapped extension stage 104, the circuit 2300 can employ a different scoring technique than that used for BLASTN applications. Whereas the preferred BLASTN scoring technique used a reward score of α for exact matches between a query sequence residue and a database sequence residue in the extension window and a penalty score of −β for a non-match between a query sequence residue and a database sequence residue in the extension window, the BLASTP scoring technique preferably uses a scoring system based on a more complex scoring matrix. FIG. 24 depicts a hardware architecture for such BLASTP scoring. As corresponding residues in the extended database sequence 2402 and extended query sequence 2404 are compared with each other (each residue being represented by a 5 bit value), these residues are read by the scoring system. Preferably an index value 2406 derived from these residues is used to look up a score 2410 stored in a scoring matrix embodied as lookup table 2408. Preferably, this index is a concatenation of the 5 bits of the database sequence residue and the query sequence residue being assessed to determine the appropriate score.

The scores found in the scoring matrix are preferably defined in accordance with the BLOSUM-62 standard. However, it should be noted that other scoring standards can readily be used in the practice of this aspect of the invention. Preferably, scoring lookup table 2408 is stored in one or more BRAM units within the FPGA on which the ungapped extension stage is deployed. Because BRAMs are dual-ported, L_{w}/2 BRAMs are preferably used to store the table 2408 to thereby allow each residue pair in the extension window to obtain its value in a single clock cycle. However, it should be noted that quad-ported BRAMs can be used to further reduce the total number of BRAMs needed for score lookups.

It should also be noted that the gapped extension stage 106 is preferably configured such that, to appropriately process the HSPs that are used as seeds for the gapped extension analysis, an appropriate window of the database sequence around the HSP must already be buffered by the gapped extension stage 106 when that HSP arrives. To ensure that the a sufficient amount of the database sequence can be buffered by the gapped extension stage 106 prior to the arrival of each HSP, a synchronization circuit 2350 such as the one shown in FIG. 23 can be employed at the output of the filter circuit 2300. Synchronization circuit 2300 is configured to interleave portions of the database sequence with the HSPs such that each HSP is preceded by an appropriate amount of the database sequence to guarantee the gapped extension stage 106 will function properly.

To achieve this, circuit 2350 preferably comprises a buffer 2352 for buffering the database sequence 2304 and a buffer 2354 for buffering the HSPs 2318 generated by circuit 2300. Logic 2356 also preferably receives the database sequence and the HSPs. Logic 2356 can be configured to maintain a running window threshold calculation for T_{w}, wherein T_{w} is set equal to the latest database position for the current HSP plus some window value W. Logic 2356 then compares this computed T_{w} value with the database positions in the database sequence 2304 to control whether database residues in the database buffer 2352 or HSPs in the HSP buffer 2354 are passed by multiplexer 2358 to the circuit output 2360, which comprises an interleaved stream of database sequence portions and HSPs. Appropriate command data can be included in the output to tag data within the stream as either database data or HSP data. Thus, the value for W can be selected such that a window of an appropriate size for the database sequence around each HSP is guaranteed. An exemplary value for W can be 500 residue positions of a sequence. However, it should be understood that other values for W could be used, and the choice as to W for a preferred embodiment can be based on the characteristics of the band used by the Stage 3 circuit to perform a banded Smith-Waterman algorithm, as explained below.

As an alternative to the synchronization circuit 2350, the system can also be set up to forward any HSPs that are out of synchronization by more than W with the database sequence to an exception handling process in software.

### 3. Gapped Extension Stage 106

The Smith-Waterman (SW) algorithm is a well-known algorithm for use in gapped extension analysis for BLAST. SW allows for insertions and deletions in the query sequence as well as matches and mismatches in the alignment. A common variant of SW is affine SW. Affine SW requires that the cost of a gap can be expressed in the form of o+k*e wherein o is the cost of an existing gap, wherein k is the length of the gap, and wherein e is the cost of extending the gap length by 1. In practice, o is usually costly, around −12, while e is usually less costly, around −3. Because one will never have gaps of length zero, one can define a value d as o+e, the cost of the first gap. In nature, when gaps in proteins do occur, they tend to be several residues long, so affine SW serves as a good model for the underlying biology.

If one next considers a database sequence x and a query sequence y, wherein m is the length of x, and wherein n is the length of y, affine SW will operate in an m*n grid representing the possibility of aligning any residue in x with any residue in y. Using two variables, i=0,1, . . . , n and j=0,1, . . . , m, for each pair of residues (i,j) wherein i≧1 and wherein j≧1, affine SW computes three values: (1) the highest scoring alignment which ends at the cell for (i,j)−M(i,j), (2) the highest scoring alignment which ends in an insertion in x−I(i,j), and (3) the highest scoring alignment which ends in a deletion in x−D(i,j).

As an initialization condition, one can set M(0,j)=I(0,j)=0 for all values of j, and one can set M(i,0)=D(i,0)=0 for all values of i. If xᵢ and yⱼ denote the i^{th} and j^{th} residues of the x and y sequences respectively, one can define a substitution matrix s such that s(xᵢ,yⱼ) gives the score of matching xᵢ and yᵢ, wherein the recurrence is then expressed as:

$$I ( i , j ) = max \{ \begin{matrix}M ( i - 1 , j ) + d \\ I ( i - 1 , j ) + e\end{matrix} \\ D ( i , j ) = max \{ \begin{matrix}M ( i , j - 1 ) + d \\ D ( i , j - 1 ) + e\end{matrix} \\ M ( i , j ) = max \{ \begin{matrix}M ( i - 1 , j - 1 ) + s ( {x}_{i} , {y}_{i} ) \\ I ( i , j ) \\ D ( i , j ) \\ 0\end{matrix}$$

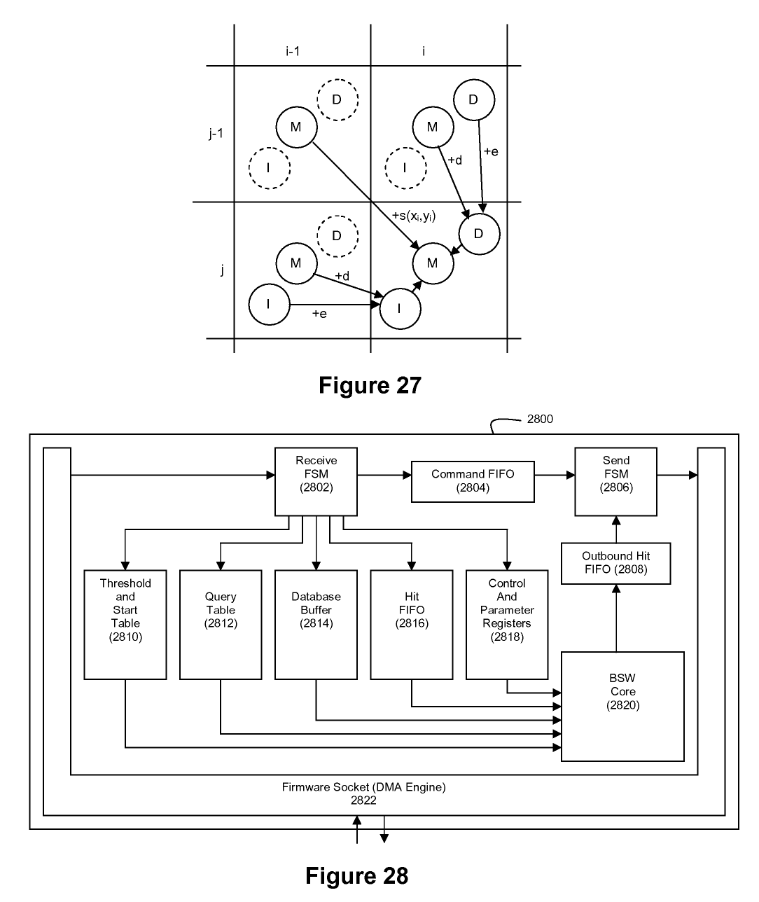

which is shown graphically by FIG. 27.

A variety of observations can be made about this recurrence. First, each cell is dependent solely on the cell to the left, above, and upper-left. Second, M(i,j) is never negative, which allows for finding strong local alignments regardless of the strength of the global alignment because a local alignment is not penalized by a negative scoring section before it. Lastly, this algorithm runs in O(mn) time and space.

In most biology applications, the majority of alignments are not statistically significant and are discarded. Because allocating and initializing a search space of mn takes significant time, linear SW is often run as a prefilter to a full SW. Linear SW is an adaptation of SW which allows the computation to be performed in linear space, but gives only the score and not the actual alignment. Alignments with high enough scores are then recomputed with SW to get the path of the alignment. Linear SW can be computed in a way consistent with the data dependencies by computing on an anti-diagonal, but in each instance just the last two iterations are stored.

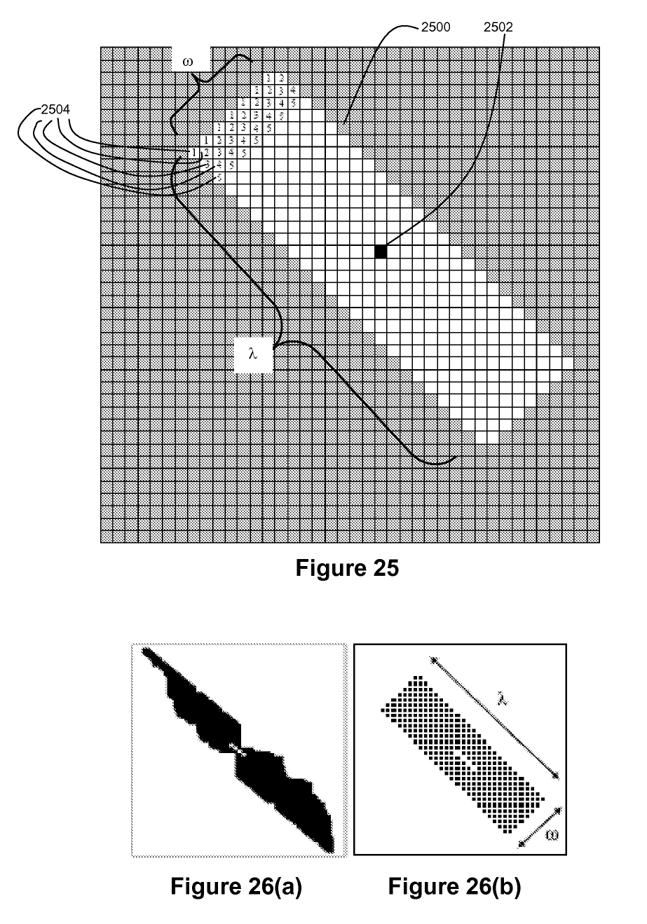

A variety of hardware deployments of the SW algorithm for use in Stage 3 BLAST processing are known in the art, and such known hardware designs can be used in the practice of the present invention. However, it should be noted that in a preferred embodiment of the present invention, Stage 3 for BLAST is implemented using a gapped extension prefilter 402 wherein the prefilter 402 employs a banded SW (BSW) algorithm for its gapped extension analysis. As shown in FIG. 25, BSW is a special variant of SW that fills a band 2500 surrounding an HSP 2502 used as a seed for the algorithm rather than doing a complete fill of the search space m*n as would be performed by a conventional full SW algorithm. Furthermore, unlike the known XDrop technique for the SW algorithm, the band 2500 has a fixed width and a maximum length, a distinction that can be seen via FIGS. 26(a) and (b). FIG. 26(a) depicts the search space around a seed for a typical software implementation of SW using the XDrop technique for NCBI BLASTP. FIG. 26(b) depicts the search space around an HSP seed for BSW in accordance with an embodiment of the invention. Each pixel within the boxes of FIGS. 26(a) and (b) represents one cell computed by the SW recurrence.

For BSW, and with reference to FIG. 25, the band's width, ω, is defined as the number of cells in each anti-diagonal 2504. The band's length, λ, is defined as the number of anti-diagonals 2504 in the band. In the example of FIG. 25, ω is 7 and λ is 48. Cells that share the same anti-diagonal are commonly numbered in FIG. 25 (for the first 5 anti-diagonals 2504). The total number of cell fills required is ω*λ. By computing just a band 2500 centered around an HSP 2502, the BSW technique can reduce the search space significantly relative to the use of regular SW (as shown in FIG. 25, the computational space of the band is significantly less than the computational space that would be required by a conventional SW (which would encompass the entire grid depicted in FIG. 25)). It should be noted that the maximum number of residues examined in both the database and query is ω+(λ/2).

Under these conditions, a successful alignment may not be the product of the seed 2502, it may start and end before the seed or start and end after the seed. To avoid this situation, an additional constraint is preferably imposed that the alignment must start before the seed 2502 and end after the seed 2502. To enforce this constraint, the hardware logic which performs the BSW algorithm preferably specifies that only scores which come after the seed can indicate a successful alignment. After the seed 2502, scores are preferably allowed to become negative, which greatly reduces the chance of a successful alignment which starts in the second half. Even with these restrictions however, the alignment does not have to go directly through the seed.

As with SW, each cell in BSW is dependent only on its left, upper and upper-left neighbors. Thus it is preferable to compute along the anti-diagonal 2504. The order of this computation can be a bit deceiving because the order of anti-diagonal computation does not proceed in a diagonal fashion but rather a stair stepping fashion. That is, after the first anti-diagonal is computed (for the anti-diagonal numbered 1 in FIG. 25), the second anti-diagonal is immediately to the right of the first and the third is immediately below the second, as shown in FIG. 25. A distinction can be made between odd anti-diagonals and even anti-diagonals where the 1^{st}, 3^{rd}, 5^{th} . . . anti-diagonals computed are odd and the 2^{nd}, 4^{th}, 6^{th} . . . are even. Preferably, the anti-diagonals are always initially numbered at one, and thus always start with an odd anti-diagonal.

A preferred design of the hardware pipeline for implementing the BSW algorithm in the gapped extension prefilter stage 402 of BLASTP can be thought of in three categories: (1) control, (2) buffering and storage, and (3) BSW computation. FIG. 28 depicts an exemplary FPGA 2800 on which a BSW prefilter stage 402 has been deployed. The control tasks involve handling all commands to and from software, directing data to the appropriate buffer, and sending successful alignments to software. Both the database sequence and the HSPs are preferably buffered, and the query and its supported data structures are preferably stored. The BSW computation can be performed by an array of elements which execute the above-described recurrence.

3.A. Control

With reference to FIG. 28, control can be implemented using three state machines and several first-in-first-out buffers (FIFOs), wherein each state machine is preferably a finite state machine (FSM) responsible for one task. Receive FSM 2802 accepts incoming commands and data via the firmware socket 2822, processes the commands and directs the data to the appropriate buffer. All commands to leave the system are queued into command FIFO 2804, and all data to leave the system is queued into outbound hit FIFO 2808. The Send FSM 2806 pulls commands and data out of these FIFOs and sends them to software. The compute state-machine which resides within the BSW core 3014 is responsible for controlling the BSW computation. The compute state-machine serves important functions of calculating the band geometry, initializing the computational core, stopping an alignment when it passes or fails, and passing successful alignments to the send FSM 2806.

3.B. Storage and Buffering

There are several parameters and tables which are preferably stored by the BSW prefilter in addition to the query sequence(s) and the database sequence. The requisite parameters for storage are λ, e, and d. Each parameter, which is preferably set using a separate command from the software, is stored in the control and parameters registers 2818, which is preferably within the hardware.

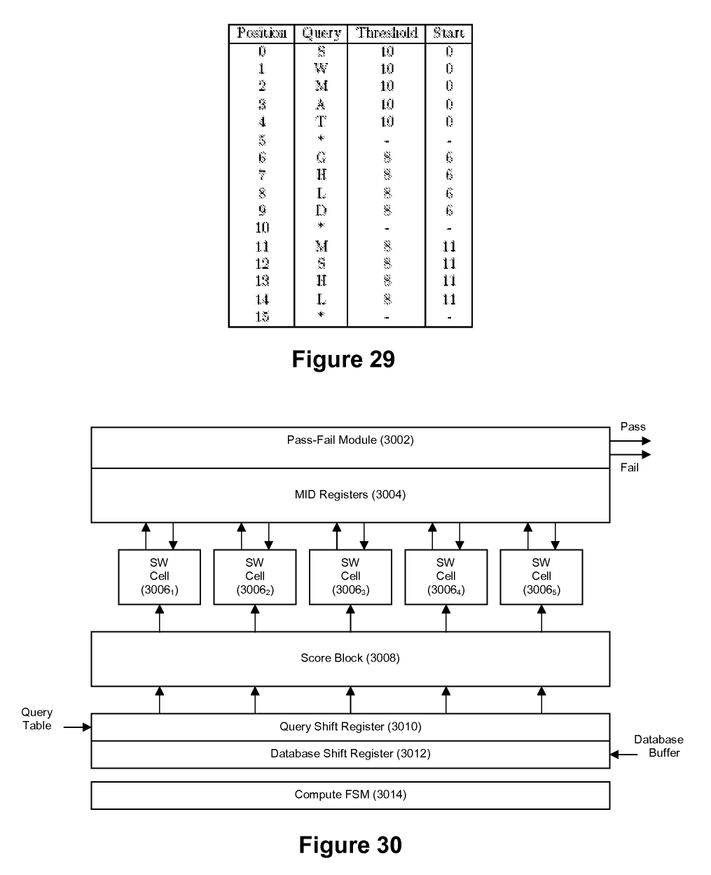

Registers 2810 preferably include a threshold table and a start table, examples of which are shown in FIG. 29. The thresholds serve to determine what constitutes a significant alignment based on the length of the query sequence. However, because multiple query sequences can be concatenated into a single run, an HSP can be from any of such multiple query sequences. To determine the correct threshold for an HSP, one can use a lookup table with the threshold defined for any position in the concatenated query sequence. This means that the hardware does not have to know which query sequence an HSP comes from to determine the threshold needed for judging the alignment. One can use a similar technique to improve running time by decreasing the average band length. The start of the band frequently falls before the start of the query sequence. Rather than calculate values that will be reset once a query sequence separator is reached, the hardware performs a lookup into the start table to determine the minimum starting position for a band. Again, the hardware is unaware of which query sequence an HSP comes from, but rather performs the lookup based on the HSP's query position.

For an exemplary maximum query length of 2048 residues (which translates to around 1.25 Kbytes), the query sequence can readily be stored in a query table 2812 located on the hardware. Because residues are consumed sequentially starting from an initial offset, the query buffer 2812 provides a FIFO-like interface. The initial address is loaded, and then the compute state-machine can request the next residue by incrementing a counter in the query table 2812.

The database sequence, however, is expected to be too large to be stored on-chip, so the BSW hardware prefilter preferably only stores an active portion of the database sequence in a database buffer 2814 that serves as a circular buffer. Because of the Stage 1 design discussed above, HSPs will not necessarily arrive in order by ascending database position. To accommodate such out-of-order arrivals, database buffer 2814 keeps a window of X residues (preferably 2048 residues) behind the database offset of the current HSP. Given that the typical out-of-orderness is around 40 residues, the database buffer 2814 is expected to support almost all out-of-order instances. In an exceptional case were an HSP is too far behind, the BSW hardware prefilter can flag an error and send that HSP to software for further processing. Another preferred feature of the database buffer 2814 is that the buffer 2814 does not service a request until it has buffered the next o+(λ/2) residues, thereby making buffer 2814 difficult to stall once computation has started. This can be implemented using a FIFO-like interface similar to the query buffer 2812, albeit that after loading the initial address, the compute state-machine must wait for the database buffer 2814 to signal that it is ready (which only happens once the buffer 2814 has buffered the next ω+(λ/2) residues).

3.C. BSW Computation

The BSW computation is carried out by the BSW core 2820. Preferably, the parallelism of the BSW algorithm is exploited such that each value in an anti-diagonal can be computed concurrently. To compute o) values simultaneously, the BSW core 2820 preferably employs o) SW computational cells. Because there will be o) cells, and the computation requires one clock cycle, the values for each anti-diagonal can be computed in a single clock cycle. As shown in FIG. 27, a cell computing M(i,j) is dependent on M(i−1,j), M(i,j−1), M(i−1,j−1), I(i−1,j), D(i,j−1), xᵢ, yⱼ, s (xᵢ, yⱼ), e, and d. Many of these resources can be shared between cells—for example, M(i+1,j−1), which is computed concurrently with M(i,j), is also dependent on M(i+1−1,j−1) (or more simply M(i,j−1)).

Rather than arrange the design in a per-cell fashion, a preferred embodiment of the BSW core 2820 can arrange the BSW computation in blocks which provide all the dependencies of one type for all cells. This allows the internal implementation of each block to change as long as it provides the same interface. FIG. 30 depicts an example of such a BSW core 2820 wherein ω is 5, wherein the BSW core 2820 is broken down into a pass/fail module 3002, a MID register block 3004 for the M, I, and D values, the ω SW cells 3006, a score block 3008, query and database sequence shift registers 3010 and 3012, and the compute state-machine, Compute FSM 3014, as described above.

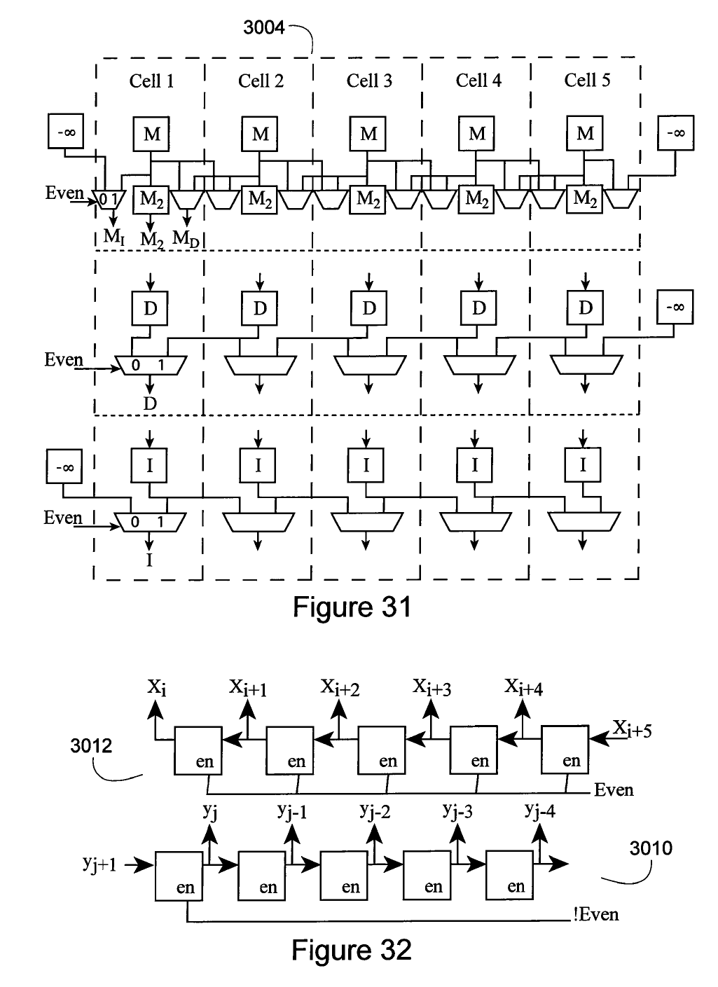

FIG. 31 depicts an exemplary embodiment for the MID register block 3004. All of the values computed by each cell 3006 are stored in the MID register block 3004. Each cell 3006 is dependent on three M values, one I value, and one D value, but the three M values are not unique to each cell. Cells that are adjacent on the anti-diagonal path both use the M value above the lower cell and to the left of the upper cell. This means, that 4*ω value registers can be used to store the M, I, and D values computed in the previous clock cycle and the M value computed two clock cycles prior. The term MI can be used to represent the M value that is used to compute a given cell's I value, that is MI will be M(i−1,j) for a cell to compute M(i,j). Similarly, the term MD can be used to represent the M value that is used to compute a given cell's D value, and the term M₂ can be used to represent the M value that is computed two clock cycles before, that is M₂ will be M(i−1,j−1) for a cell to compute M(i,j). On an odd diagonal, each cell is dependent on (1) the MD and D values it computed in the previous clock cycle, (2) the MI and I values that its left neighbor computed in the previous clock cycle, and (3) M₂. On an even diagonal, each cell is dependent on (1) the MI and I values it computed in the previous clock cycle, (2) the MD and D values that its right neighbor computed in the previous clock cycle, and (3) M₂. As shown in FIG. 31, to implement this, the MID block 3004 uses registers and two input multiplexers. The control hardware generates a signal to indicate whether the current anti-diagonal is even or odd, and this signal can be used as the selection signal for the multiplexers. To prevent alignments from starting on the edge of the band, scores from outside the band are set to negative infinity.

FIG. 32 depicts an exemplary query shift register 3010 and database shift register 3012. The complete query sequence is preferably stored in block RAM on the chip, and the relevant window of the database sequence is preferably stored in its own buffer also implemented with block RAMs. A challenge is that each of the o cells need to access a different residue of both the query sequence and the database sequence. To solve this challenge, one can note the locality of the dependencies. Assume that cell 1, the bottom-left-most cell is computing M(i,j), and is therefore dependent on s(xᵢ,yⱼ). By the geometry of the cells, one knows that cell ω is computing M(i+(ω−1),j-(ω−1)) and is therefore dependent on the value s(x_{i+(ω-1}, y_{j-(ω-1)}). Thus, at any point in time, the cells must have access to o) consecutive values of both the database sequence and the query sequence. For a clock cycle following the example above, the system will be dependent on database residues xᵢ₊₁, . . . x_{i+1+(ω-1)}) and yⱼ, . . . y_{j-(ω-1}). Thus, the system needs one new residue and can discard one old residue per clock cycle while retaining the other ω−1 residues.

As shown in FIG. 32, the query and database shift registers 3010 and 3012 can be implemented with a pair of parallel tap shift registers—one for the query and one for the database. Each of these shift registers comprises a series of registers whose outputs are connected to the input of an adjacent register and output to the scoring block 3008. The individual registers preferably have an enable signal which allows shifting only when desired. During normal running, the database is shifted on even anti-diagonals, and the query is shifted on odd anti-diagonals. The shift actually occurs at the end of the cycle, but the score block 3008 introduces a one clock cycle delay, thereby causing the effect of shifting the scores at the end of an odd anti-diagonal for the database and at the end of an even anti-diagonal for the query.

The score block 3008 takes in the xᵢ₊₁, . . . x_{i+1+(ω-1)} and yⱼ, . . . y_{j-(ω-1)} residues from the shift registers 3010 and 3012 to produce the required s(xᵢ,yⱼ), . . . s(x_{i+(ω-1)}, y_{j-(ω-1)}) values. The score block 3008 can be implemented using a lookup table in block RAM. To generate an address for the lookup table, the score block 3008 can concatenate the x and y value for each clock cycle. If each residue is represented with 5-bits, the total address space will be 10-bits. Each score value can be represented as a signed 8-bit value so that the total size of the table is 1 Kbyte—which is small enough to fit in one block RAM. Because each residue pair may be different, the design is preferably configured to service all requests simultaneously and independently. Since each block RAM provides two independent ports and by using ω/2 replicated block RAMs for the lookup table, the block RAMs can take one cycle to produce data. As such, the inputs are preferably sent one clock cycle ahead.

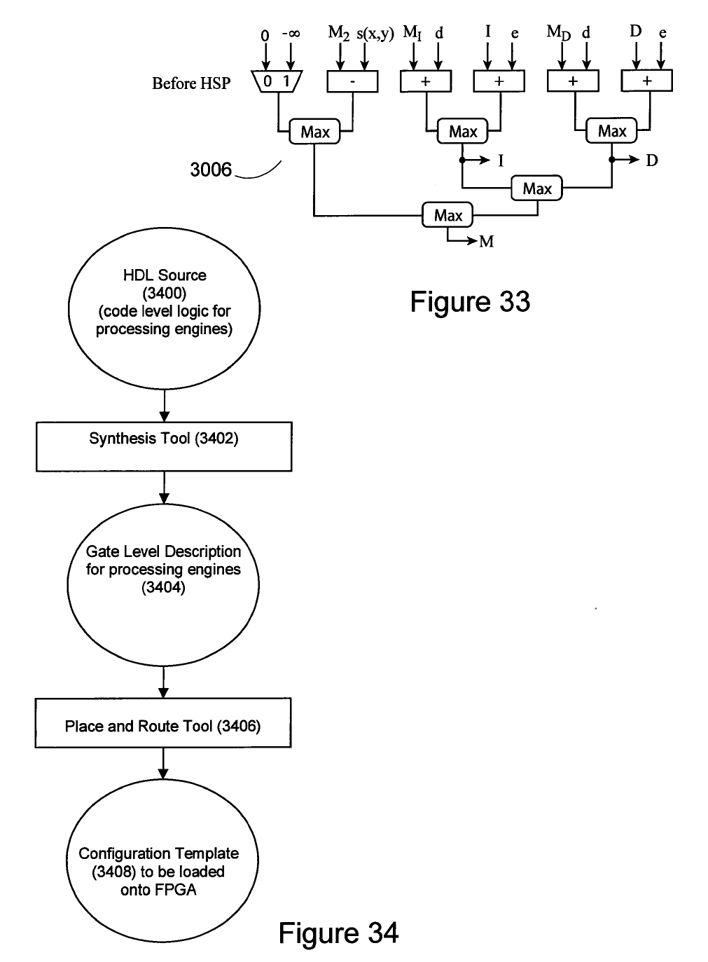

FIG. 33 depicts an exemplary individual SW cell 3006. Each cell 3006 is preferably comprised solely of combinatorial logic because all of the values used by the cell are stored in the MID block 3004. Each cell 3006 preferably comprises four adders, five maximizers, and a two-input multiplexer to realize the SW recurrence, as shown in FIG. 33. Internally, each maximizer can be implemented as a comparator and a multiplexer. The two input multiplexer can be used to select the minimum value, either zero for all the anti-diagonals before the HSP or negative infinity after the HSP.

The pass-fail block 3002 simultaneously compares the o cell scores in an anti-diagonal against a threshold from the threshold table. If any cell value exceeds the threshold, the HSP is deemed significant and is immediately passed through to software for further processing (by way of FIFO 2808 and the Send FSM 2806). In some circumstances, it may be desirable to terminate extension early. To achieve this, once an alignment crosses the HSP, its score is never clamped to zero, but may become negative. In instances where only negative scores are observed on all cells on two consecutive anti-diagonals, the extension process is terminated. Most HSPs that yield no high-scoring gapped alignment are rapidly discarded by this optimization.

### 4. Additional Details and Embodiments

With reference to the embodiment of FIG. 22, it can be seen that software executing on a CPU operates in conjunction with the firmware deployed on boards 250. Preferably, the software deployed on the CPU is organized as a multi-threaded application that comprises independently executing components that communicate via queues. In such an embodiment wherein one or more FPGAs are deployed on each board 250, the software can fall into three categories: BLASTP support routines, FPGA interface code, and NCBI BLAST software. The support routines are configured to populate data structures such as the word matching lookup table used in the hardware design. The FPGA interface code is configured to use an API to perform low-level communication tasks with the FAMs deployed on the FPGAs.

The NCBI codebase can be leveraged in such a design. Fundamental support routines such as I/O processing, query filtering, and the generation of sequence statistics can be re-used. Further, support for additional BLAST programs such as blastx and tblastn can be more easily added at a later stage. Furthermore, the user interface, including command-line options, input sequence format, and output alignment format from NCBI BLAST can be preserved. This facilitates transparent migration for end users and seamless integration with the large set of applications that are designed to work with NCBI BLAST.

Query pre-processing, as shown in FIG. 22, involves preparing the necessary data structures required by the hardware circuits on boards 250 and the NCBI BLAST software pipeline. The input query sequences are first examined to mask low complexity regions (short repeats, or residues that are over-represented), which would otherwise generate statistically significant but biologically spurious alignments. SEG filtering replaces residues contained in low complexity regions with the “invalid” control character. The query sequence is packed, 5 bits per base in 60-bit words, and encoded in big-endian format for use by the hardware. Three main operations are then performed on the input query sequence set. Query bin packing, described in greater detail below, concatenates smaller sequences to generate composites of the optimal size for the hardware. The neighborhood of all w-mers in the packed sequence is generated (as previously described), and lookup tables are created for use in the word matching stage. Preferably, query sequences are pre-processed at a sufficiently high rate to prevent starvation of the hardware stages.

The NCBI Initialize code shown in FIG. 22 preferably executes part of the traditional NCBI pipeline that creates the state for the search process. The query data structures are then loaded and the search parameters are initialized in hardware. Finally, the database sequence is streamed through the hardware. The ingest rate to the boards can be modulated by a backpressure signal that is propagated backward from the hardware modules.

Board 250₁ preferably performs the first two stages of the BLASTP pipeline. The HSPs generated by the ungapped extension can be sent back to the host CPU, where they are multiplexed with the database stream. However, it should be noted that if Stage 2 employs the synchronization circuit 2350 that is shown in FIG. 23, the CPU-based stage 3 preprocessing can be eliminated from the flow of FIG. 22. Board 2502 then performs the BSW algorithm discussed above to generate statistically significant HSPs. Thereafter, the NCBI BLASTP pipeline in software can be resumed on the host CPU at the X-drop gapped extension stage, and alignments are generated after post-processing.

FPGA communication wrappers, device drivers, and hardware DMA engines can be those disclosed in the referenced and incorporated Ser. No. 11/339,892 patent application.

Query bin packing is an optimization that can be performed as part of the query pre-processing to accelerate the BLAST search process. With query bin packing, multiple short query sequences are concatenated and processed during a single pass over the database sequence. Query sequences larger than the maximum supported size are broken into smaller, overlapping chunks and processed over several passes of the database sequence. Query bin packing can be particularly useful for BLASTP applications when the maximum query sequence size is 2048 residues because the average protein sequence in typical sequence databases is only around 300 residues.

Sequence packing reduces the overhead of each pass, and so ensures that the resources available are fully utilized. However, a number of caveats are preferably first addressed. First, to ensure that generated alignments do not cross query sequence boundaries, an invalid sequence control character is preferably used to separate the different commonly packed query sequences. The word matching stage is preferably configured to detect and reject w-mers that cross these boundaries. Similar safeguards are preferably employed during downstream extension stages. Second, the HSP coordinates returned by the hardware stages must be translated to the reference system of the individual components. Finally, the process of packing a set of query sequences in an online configuration is preferably optimized to reduce the overhead to a minimum.

For a query bin packing problem, one starts from a list of L=(q₁,q₂, . . . , qₙ) query sequences, each of length lᵢε(0,2048), that must be packed into a minimum number of bins, each of capacity 2048. This is a classical one-dimensional bin-packing problem that is known to be NP-hard. A variety of algorithms can be used that guarantee to use no more than a constant factor of bins used by the optimal solution. (See Hochbaum, D., Approximation algorithms for NP-hard problems, PWS Publishing Co., Boston, Mass., 1997, the entire disclosure of which is incorporated herein by reference).

If one lets B₁B₂, . . . be a list of bins indexed by the order of their creation, then Bₖ¹ can be the sum of the lengths of the query sequences packed into bin Bₖ. With a Next Fit (NF) query bin packing algorithm, the query qᵢ is added to the most recently created bin Bₖ if lᵢ≦2048−Bₖ¹ is satisfied. Otherwise, Bₖ is closed and qᵢ is placed in a new bin Bₖ₊ₗ, which now becomes the active bin. The NF algorithm is guaranteed to use not more than twice the number of bins used by the optimal solution.

A First Fit (FF) query bin packing algorithm attempts to place the query qᵢ in the first bin in which it can fit, i.e., the lowest indexed bin Bₖ such that the condition lᵢ≦2048−Bₖ¹ is satisfied. If no bin with sufficient room exists, a new one is created with qᵢ as its first sequence. The FF algorithm uses no more than 17/10 the number of bins used by the optimal solution.

The NF and FF algorithms can be improved by first sorting the query list by decreasing sequence lengths before applying the packing rules. The corresponding algorithms can be termed Next Fit Decreasing (NFD) and First Fit Decreasing (FFD) respectively. It can be shown that FFD uses no more than 11/9 the number of bins used by the optimal solution.

The performance of the NF and FF approximation algorithms were tested over 4,241 sequences (1,348,939 residues) of the Escherichia coli k12 proteome. The length of each query sequence was increased by one to accommodate the sequence control character. The capacity of each bin was set to 2048 sequence residues. Bin packing was performed either in the original order of the sequence in the input file or after sorting by decreasing sequence length. An optimal solution for this input set uses at least 1,353,180/2048=661 bins. Table 4 below illustrates the results of this testing.

TABLE 4
Performance of the Query Bin Packing Approximate Algorithms

Bins

| Algorithm | Unsorted | Sorted |
|---|---|---|
| NF | 740 | 755 |
| FF | 667 | 662 |

As can be seen from Table 4, both algorithms perform considerably better than the worst case. FF performs best on the sorted list of query sequences, using only one more bin than the optimal solution. Sorting the list of query sequences is possible when they are known in advance. In certain configuration, such as when the BLASTP pipeline is configured to service requests from a web server, such sorting will not likely be feasible. In such approaches where sequences cannot be sorted, the FF rule uses just six more bins than the optimum. Thus, in instances where the query set is known in advance, FFD (which is an improvement on FF) can serve as a good method for query bin packing.

The BLASTP pipeline is stalled during the query bin packing pre-processing computation. FF keeps every bin open until the entire query set is processed. The NF algorithm may be used if this pre-processing time becomes a major concern. Since only the most recent bin is inspected with NF, all previously closed query bins may be dispatched for processing in the pipeline. However, it should also be noted that NF increases the number of database passes required and causes a corresponding increase in execution time.

It is also worth noting that the deployment of BLAST on reconfigurable logic as described herein and as described in the related U.S. patent application Ser. No. 11/359,285 allows for BLAST users to accelerate similarity searching for a plurality of different types of sequence analysis (e.g., both BLASTN searches and BLASTP searches) while using the same board(s) 250. That is, a computer system used by a searcher can store a plurality of hardware templates in memory, wherein at least one of the templates defines a FAM chain 230 for BLASTN similarity searching while another at least one template defines a FAM chain 230 for BLASTP similarity searching. Depending on whether the user wants to perform BLASTP or BLASTN similarity searching, the processor 208 can cause an appropriate one of the prestored templates to be loaded onto the reconfigurable logic device to carry out the similarity search (or can generate an appropriate template for loading onto the reconfigurable logic device). Once the reconfigurable logic device 202 has been configured with the appropriate FAM chain, the reconfigurable logic device 202 will be ready to receive the instantiation parameters such as, for BLASTP processing, the position identifiers for storage in lookup table 514. If the searcher later wants to perform a sequence analysis using a different search methodology, he/she can then instruct the computer system to load a new template onto the reconfigurable logic device such that the reconfigurable logic device is reconfigured for the different search (e.g., reconfiguring the FPGA to perform a BLASTN search when it was previously configured for a BLASTP search).

Further still, a variety of templates for each type of BLAST processing may be developed with different pipeline characteristics (e.g., one template defining a FAM chain 230 wherein only Stages 1 and 2 of BLASTP are performed on the reconfigurable logic device 202, another template defining a FAM chain 230 wherein all stages of BLASTP are performed on the reconfigurable logic device 202, and another template defining a FAM chain 230 wherein only Stage 1 of BLASTP is performed on the reconfigurable logic device). With such a library of prestored templates available for loading onto the reconfigurable logic device, users can be provided with the flexibility to choose a type of BLAST processing that suits their particular needs. Additional details concerning the loading of templates onto reconfigurable logic devices can be found in the above-referenced patent applications: U.S. patent application Ser. No. 10/153,151, published PCT applications WO 05/048134 and WO 05/026925, and U.S. patent application Ser. No. 11/339,892.

As disclosed in the above-referenced and incorporated WO 05/048134 and WO 05/026925 patent applications, to generate a template for loading onto an FPGA, the process flow of FIG. 34 can be performed. First, code level logic 3400 for the desired processing engines that defines both the operation of the engines and their interaction with each other is created. This code, at the register level, is preferably Hardware Description Language (HDL) source code, and it can be created using standard programming languages and techniques. As examples of an HDL, VHDL or Verilog can be used. With respect to an embodiment where stages 1 and 2 of BLASTP are deployed on a single FPGA on board 250, (see FIG. 22), this HDL code 3400 would comprise a data structure corresponding to the stage 1 circuit 102 as previously described and a a data structure corresponding to the stage 2 circuit 104 as previously described. This code 3400 can also comprise a data structure corresponding to the stage 3 circuit 106, which in turn would be converted into a template for loading onto the FPGA deployed on board 2502.

Thereafter, at step 3402, a synthesis tool is used to convert the HDL source code 3400 into a data structure that is a gate level logic description 3404 for the processing engines. A preferred synthesis tool is the well-known Synplicity Pro software provided by Synplicity, and a preferred gate level description 3404 is an EDIF netlist. However, it should be noted that other synthesis tools and gate level descriptions can be used. Next, at step 3406, a place and route tool is used to convert the EDIF netlist 3404 into a data structure that comprises the template 3408 that is to be loaded into the FPGA. A preferred place and route tool is the Xilinx ISE toolset that includes functionality for mapping, timing analysis, and output generation, as is known in the art. However, other place and route tools can be used in the practice of the present invention. The template 3408 is a bit configuration file that can be loaded into an FPGA through the FPGA's Joint Test Access Group (JTAG) multipin interface, as is known in the art.

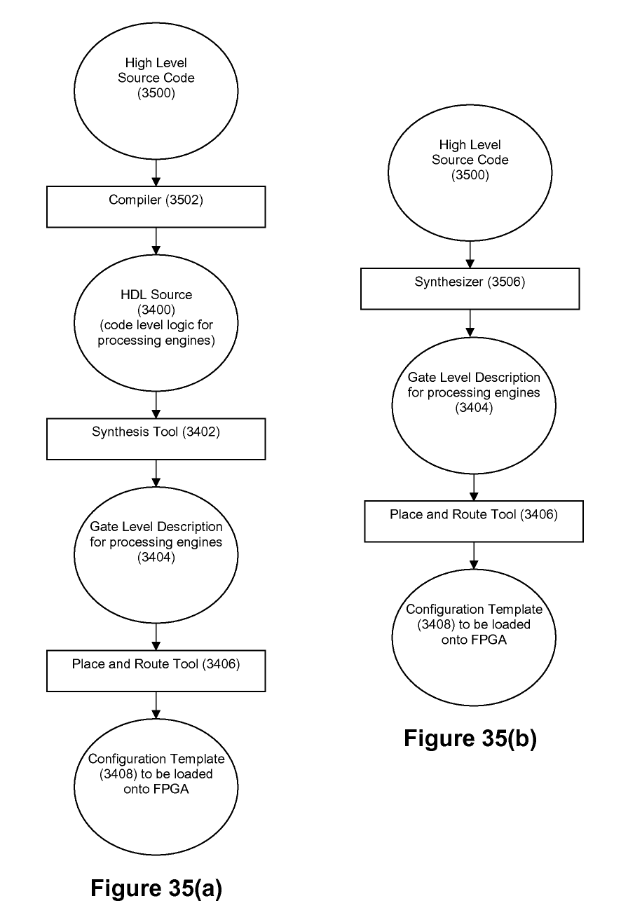

However, it should also be noted that the process of generating template 3408 can begin at a higher level, as shown in FIGS. 35(a) and (b). Thus, a user can create a data structure that comprises high level source code 3500. An example of a high level source code language is SystemC, an IEEE standard language; however, it should be noted that other high level languages could be used. With respect to an embodiment where stages 1 and 2 of BLASTP are deployed on a single FPGA on board 250₁ (see FIG. 22), this high level code 3500 would comprise a data structure corresponding to the stage 1 circuit 102 as previously described and a data structure corresponding to the stage 2 circuit 104 as previously described. This code 3500 can also comprise a data structure corresponding to the stage 3 circuit 106, which in turn would be converted into a template for loading onto the FPGA deployed on board 2502.

At step 3502, a compiler such as a SystemC compiler can be used to convert the high level source code 3500 to the HDL code 3400. Thereafter, the process flow can proceed as described in FIG. 34 to generate the desired template 3408. It should be noted that the compiler and synthesizer can operate together such that the HDL code 3400 is transparent to a user (e.g., the HDL source code 3400 resides in a temporary file used by the toolset for the synthesizing step following the compiling step. Further still, as shown in FIG. 35(b), the high level code 3502 may also be directly synthesized at step 3506 to the gate level code 3404.

As would be readily understood by those having ordinary skill in the art, the process flows of FIGS. 34 and 35(a)-(b) can not only be used to generate configuration templates for FPGAs, but also for other hardware logic devices, such as other reconfigurable logic devices and ASICs.

It should also be noted that, while a preferred embodiment of the present invention is configured to perform BLASTP similarity searching between protein biosequences, the architecture of the present invention can also be employed to perform comparisons for other sequences. For example, the sequence can be in the form of a profile, wherein the items into which the sequence's bit values are grouped comprise profile columns, as explained below.

4.A. Profiles

A profile is a model describing a collection of sequences. A profile P describes sequences of a fixed length L over an alphabet A (e.g. DNA bases or amino acids). Profiles are represented as matrices of size AxL, where the jth column of P (1<=j<=L) describes the jth position of a sequence. There are several variants of profiles, which are described below.

Frequency matrix. The simplest form of profile describes the character frequencies observed in a collection C of sequences of common length L. If character c occurs at position j in m of the sequences in C, then P(c,j)=m. The total of the entries in each column is therefore the number of sequences in C. For example, a frequency matrix derived from a set of 10 sequences of length 4 might look like the following:

| | | | | |
|---|---|---|---|---|
| A | 3 | 5 | 7 | 9 |
| C | 2 | 1 | 1 | 0 |
| G | 4 | 2 | 1 | 1 |
| T | 1 | 2 | 1 | 0 |

Probabilistic model. A probabilistic profile describes a probability distribution over sequences of length L. The profile entry P(c,j) (where c is a character from alphabet A) gives the probability of seeing character c at sequence position j. Hence, the sum of P(c,j) over all c in A is 1 for any j. The probability that a sequence sampled uniformly at random from P is precisely the sequence s is given by

$$Pr ( s \vert P ) = {\prod }_{j = 1}^{L} P ( s [ j ] , j ) .$$

Note that the probability of seeing character c in column j is independent of the probability of seeing character c′ in column k, for k !=j.

Typically, a probabilistic profile is derived from a frequency matrix for a collection of sequences. The probabilities are simply the counts, normalized by the total number of sequences in each column. For example, the probability version of the above profile might look like the following:

| | | | | |
|---|---|---|---|---|
| A | 0.3 | 0.5 | 0.7 | 0.9 |
| C | 0.2 | 0.1 | 0.1 | 0.0 |
| G | 0.4 | 0.2 | 0.1 | 0.1 |
| T | 0.1 | 0.2 | 0.1 | 0.0 |

In practice, these probabilities are sometimes adjusted with prior weights or pseudocounts, e.g. to avoid having any zero entries in a profile and hence avoid assigning any sequence zero probability under the model.

Score matrix. A third use of profiles is as a matrix of similarity scores. In this formulation, each entry of P is an arbitrary real number (though the entries may be rounded to integers for efficiency). Higher scores represent greater similarity, while lower scores represent lesser similarity. The similarity score of a sequence s against profile P is then given by

$$score ( s \vert P ) = {\sum }_{j = 1}^{L} P ( s [ j ] , j ) .$$

Again, each sequence position contributes independently to the score.

A common way to produce score-based profiles is as a log-likelihood ratio (LLR) matrix. Given two probabilistic profiles P and P₀, an LLR score profile Pᵣ can be defined as follows:

$${P}_{r} ( c , j ) = log ( \frac{P ( c , j )}{{P}_{0} ( c , j )} ) .$$

Higher scores in the resulting LLR matrix correspond to characters that are more likely to occur at position j under model P than under model P₀. Typically, P₀ is a null model describing an “uninteresting” sequence, while P describes a family of interesting sequences such as transcription factor binding sites or protein motifs.

This form of profile is sometimes called a position-specific scoring matrix (PSSM).

4.B. Comparison Tasks Involving Profiles

One may extend the pairwise sequence comparison problem to permit one or both sides of the comparison to be a profile. The following two problem statements describe well-known bioinformatics computations.

Problem (1): given a query profile P representing a score matrix, and a database D of sequences, find all substrings s of sequences from D such that score(s|P) is at least some threshold value T.

Problem (1′): given a query sequences s and a database D of profiles representing score matrices, find all profiles P in D such that for some substring s′ of s, score (s′|P) is at least some threshold value T.

Problem (2): given a query profile P representing a frequency matrix, and a database D of profiles representing frequency matrices, find all pairs of profiles (P, P′) with similarity above a threshold value T.

Problem (1) describes the core computation of PSI-BLAST, while (1′) describes the core computation of (e.g.) RPS-BLAST and the BLOCKS Searcher. (See Altschul et al., Gapped BLAST and PSI-BLAST: a new generation of protein database search programs, Nucleic Acids Res, 1997, 25(17): p. 3389-3402; Machler-Bauer et al., CDD: a conserved domain database for interactive domain family analysis, Nucleic Acids Res., 2007, 35(Database Issue): p. D237-40; and Pietrokovski et al., The Blocks database—a system for protein classification, Nucleic Acid Res, 1996, 24(1): p. 197-200, the entire disclosures of each of which are incorporated herein by reference). These tools are all used to recognize known motifs in biosequences.

A motif is a sequence pattern that occurs (with variation) in many different sequences. Biologists collect examples of a motif and summarize the result as a frequency profile P. To use the profile P in search, it is converted to a probabilistic model and thence to an LLR score matrix using some background model P₀. In Problem (1), a single profile representing a motif is scanned against a sequence database to find additional instances of the motif; in Problem (1′), a single sequence is scanned against a database of motifs to discover which motifs are present in the sequence.

Problem (2) describes the core computations of several tools, including LAMA, IMPALA, and PhyloNet. (See Pietrokovski S., Searching databases of conserved sequence regions by aligning protein multiple-alignments, Nucleic Acids Res, 1996, 24(19): p. 3836-45; Schaffer et al., IMPALA: matching a protein sequence against a collection of PSI-BLAST-constructed position-specific score matrices, Bioinformatics, 1999, 15(12),p. 1000-11; and Wang and Stormo, Identifying the conserved network of cis-regulatory sites of a eukaryotic genome, Proc. of Nat'l Acad. Sci. USA, 2005, 102(48): p. 17400-5, the entire disclosures of each of which are incorporated herein by reference). The inputs to this problem are typically collections of aligned DNA or protein sequences, where each collection has been converted to a frequency matrix. The goal is to discover occurrences of the same motif in two or more collections of sequences, which may be used as evidence that these sequences share a common function or evolutionary ancestor.

The application defines a function Z to measure the similarity of two profile columns. Given two profiles P, P′ of common length L, the similarity score of P with P′ is then

$${\sum }_{j = 1}^{L} Z ( P [ * , j ] , {P}^{′} [ * , j ] ) .$$

To compare profiles of unequal length, one may compute their optimal local alignment using the same algorithms (Smith-Waterman, etc.) used to align sequences, using the function Z to score each pair of aligned columns. In practice, programs that compare profiles do not permit insertion and deletion, and thus only ungapped alignments are needed and not gapped alignments.

4.C. Implementing Profile Comparison with a Hardware BLAST Circuit:

Solutions to Problems (1), (1′), and (2) above using a BLASTP-like seeded alignment algorithm are now described. For Problems (1) and (1′), the implementation corresponds to a hardware realization for PSI-BLAST, and for Problem (2), the implementation corresponds to a hardware realization for PhyloNet. As noted above, the hardware pipeline need not employ a gapped extension stage.

The similarity search problems defined above can be implemented naively by full pairwise comparison of query and database. For Problem (1) with a query profile P of length L, this entails computing, for each sequence s in D, the similarity scores score (s[i . . . i+L-l]|P) for 1<=i<=|s|−L+1 and comparing each score to the threshold T. For Problem (1′), a comparable computation is performed between the query sequence s and each profile P in D. For Problem (2), the query profile P is compared to each other profile P′ in D by ungapped dynamic programming with score function Z, to find the optimal local alignment of P to P′. Each of these implementations is analogous to naïve comparison between a query sequence and a database of sequences; only the scoring function has changed in each case.

Just as BLAST uses seeded alignment to accelerate sequence-to-sequence comparison, one may apply seeded alignment to accelerate comparisons between sequences and profiles, or between profiles and profiles. The seeded approach has two stages, corresponding to Stage 1 and Stage 2 of the BLASTP pipeline. In Stage 1, one can apply the previously-described hashing approach after first converting the profiles to a form that permits hash-based comparison. In Stage 2, one can implement ungapped dynamic programming to extend each seed, using the full profiles with their corresponding scoring functions as described in the previous paragraph.

As shown above, stage 1 of BLASTP derives high performance from being able to scan the database in linear time to find all word matches to the query, regardless of the query's length. The linear scan is implemented by hashing each word in the query into a table; each word in the database is then looked up in this table to determine if it (or another word in its high-scoring neighborhood) is present in the query.

In Problem (1), the query is a profile P of length L. One may define the (w,T)-neighborhood of profile P to be all strings s of length w, such that for some j, 1<=j<=L−w+1,

$${\sum }_{i = 0}^{w - 1} P ( s [ i + 1 ] , j + i ) \geq T .$$

In other words, the neighborhood of P is the set of all w-mers that score at least T when aligned at some offset into P. This definition is precisely analogous to the (w,T)-neighborhood of a biosequence as used by BLASTP, except that the profile itself, rather than some external scoring function, supplies the scores.

Stage 1 for Problem (1) can be implemented as follows using the stage 1 hardware circuit described above: convert the query profile P to its (w,T)-neighborhood; then hash this neighborhood; and finally, scan the sequence database against the resulting hash table and forward all w-mer hits (more precisely, all two-hits) to Stage 2. This implementation corresponds to Stage 1 of PSI-BLAST.

For Problem (1′), the profiles form the database, while the query is a sequence. RPS-BLAST is believed to implement Stage 1 for this problem by constructing neighborhood hash tables for each profile in the database, then sequentially scanning the query against each of these hash tables to generate w-mer hits. The hash tables are precomputed and stored along with the database, then read in during the search. RPS-BLAST may choose to hash multiple profiles' neighborhoods in one table to reduce the total number of tables used.

In Problem (2), both query and database consist of profiles, with a similarity scoring function Z on their columns. Simply creating the neighborhood of the query is insufficient, because one cannot perform a hash lookup on a profile. A solution to this problem is to quantize the columns of the input profiles to create sequences, as follows. First, define a set of k centers, each of which is a valid profile column. Associate with each center Cᵢ a code bᵢ, and define a scoring function Y on codes by Y(bᵢ,bⱼ)=Z(Cᵢ,Cⱼ). Now, map each column of the query and of every database profile to the center that is most similar to it, and replace it by the code for that center. Finally, execute BLASTP Stage 1 to generate hits between the code sequence for the query profile and the code sequences for every database profile, using the scoring function Y, and forward those hits to Stage 2.

A software realization of the above scheme may be found in the PhyloNet program. The authors therein define a set of 15 centers that were chosen to maximize the total similarity between a large database of columns from real biological profiles and the most similar center to each column. Similarity between profile columns and centers was measured using the scoring function Z on columns, which for PhyloNet is the Average Log-Likelihood Ratio (ALLR) score. (See Wang and Stormo, Combining phylogenetic data with co-regulated genes to identify regulatory motifs, Bioinformatics, 2003, 19(18): p. 2369-80, the entire disclosure of which is incorporated herein by reference).

Using the implementation techniques described above, profile-sequence and profile-profile comparison may be implemented on a BLASTP hardware pipeline, essentially configuring the BLASTP pipeline to perform PSI-BLAST and PhyloNet computations.

To implement the extended Stage 1 computation for Problem (1) above, one would extend the software-based hash table construction to implement neighborhood generation for profiles, just as is done in PSI-BLAST. The Stage 1 hardware itself would remain unchanged. For Problem (2) above, one would likely implement the conversion of profiles to code sequences offline, constructing a code database that parallels the profile database. The code database, along with a hash table generated from the encoded query, would be used by the Stage 1 hardware. The only changes required to the Stage 1 hardware would be to change its alphabet size to reflect the number k of distinct codes, rather than the number of characters in the underlying sequence alphabet.

In Stage 2, the extension algorithm currently implemented by the ungapped extension stage may be used unchanged for Problems (1) and (2), with the single exception of the scoring function. In the current Stage 2 score computation block, each pair of aligned amino acids is scored using a lookup into a fixed score matrix. In the proposed extension, this lookup would be replaced by a circuit that evaluates the necessary score function on its inputs. For Problem (1), the inputs are a sequence character c and a profile column P(*,j), and the circuit simply returns P(c,j). For Problem (2), the inputs are two profile columns Cᵢ and Cⱼ, and the circuit implements the scoring function Z.

The database input to the BLASTP hardware pipeline would remain a stream of characters (DNA bases or amino acids) for Problem (1). For Problem (2), there would be two parallel database streams: one with the original profile columns, and one with the corresponding codes. The first stream is used by Stage 2, while the second is used by Stage 1.

While the present invention has been described above in relation to its preferred embodiments, various modifications may be made thereto that still fall within the invention's scope. Such modifications to the invention will be recognizable upon review of the teachings herein. Accordingly, the full scope of the present invention is to be defined solely by the appended claims and their legal equivalents.

What is claimed is:

1. A data processing apparatus for sequence alignment searching, the apparatus comprising:
a first stage configured to (1) receive a bit stream that is representative of a database sequence and (2) process the bit stream to produce a plurality of seeds, each seed being indicative of a similarity between a substring of the database sequence and a substring of a query sequence;
a second stage configured to perform an ungapped extension analysis on the seeds generated by the first stage, thereby generating a plurality of high scoring pairs (HSPs); and
a third stage configured to perform a gapped extension analysis on the HSPs generated by the second stage, thereby determining whether any HSPs exist that will produce alignment of interest between the database sequence and the query sequence; and
wherein the first stage, the second stage, and at least a portion of the third stage are implemented as a data processing pipeline on at least one hardware logic device.

2. The apparatus of claim 1 wherein the at least one hardware logic device comprises at least one reconfigurable logic device.

3. The apparatus of claim 2 wherein the at least one reconfigurable logic device comprises at least one field programmable gate array (FPGA).

4. The apparatus of claim 1 wherein the first stage comprises a BLASTP seed generation stage, wherein the second stage comprises a BLASTP ungapped extension stage, and wherein the third stage comprises a BLASTP gapped extension stage.

5. The apparatus of claim 1 wherein the first stage, the second stage and all of the third stage is implemented as a data processing pipeline on at least one hardware logic device.

6. A method for sequence alignment searching, the method comprising:
generating a plurality of seeds from a database sequence and a query sequence;
performing an ungapped extension analysis on the generated seeds, thereby generating a plurality of high scoring pairs (HSPs);
performing a gapped extension analysis on the generated HSPs, thereby determining whether any HSPs will produce an alignment of interest between the database sequence and the query sequence; and
performing the seed generating step, ungapped extension analysis step and at least a portion of the gapped extension analysis step in a pipelined fashion on at least one hardware logic device.

7. The method of claim 6 wherein the at least one hardware logic device comprises at least one reconfigurable logic device.

8. The method of claim 7 wherein the database sequence corresponds to a protein biosequence.

9. The method of claim 8 wherein the query sequence corresponds to a protein biosequence.

10. The method of claim 9 further comprising performing the seed generating step, the ungapped extension analysis step and the gapped extension analysis step for BLASTP.

11. The method of claim 7 wherein the query sequence corresponds to a protein biosequence.

12. The method of 7 wherein the at least one reconfigurable logic device comprises at least one field programmable gate array (FPGA).

13. The method of claim 6 wherein the performing step comprises performing the seed generating step, ungapped extension analysis step all of the gapped extension analysis step in a pipelined fashion on at least one hardware logic device.

14. A hardware configured data processing apparatus for sequence alignment searching, the apparatus comprising at least one hardware logic device configured to (1) receive a bit stream that is representative of a database sequence, (2) process the bit stream to produce a plurality of seeds, each seed being indicative of a similarity between a substring of the database sequence and a substring of a query sequence, (3) perform an ungapped extension analysis on the generated seeds, thereby generating a plurality of high scoring pairs (HSPs), and (4) perform a gapped extension analysis on the generated HSPs, thereby determining whether any HSPs exist that will produce alignment of interest between the database sequence and the query sequence.

15. A computer-readable medium for sequence alignment searching, the computer-readable medium comprising:
a data structure comprising (1) first logic for a hardware logic device, the first logic configured to (a) receive a bit stream that is representative of a database sequence and (b) process the bit stream to produce a plurality of seeds, each seed being indicative of a similarity between a substring of the database sequence and a substring of a query sequence, (2) second logic for a hardware logic device, the second logic configured to perform an ungapped extension analysis on the generated seeds, thereby generating a plurality of high scoring pairs (HSPs), and (3) third logic for a hardware logic device, the third logic configured to perform a gapped extension analysis on the generated HSPs, thereby determining whether any HSPs exist that will produce alignment of interest between the database sequence and the query sequence, wherein the data structure is configured such that the first logic, the second logic, and the third logic will be implemented as a data processing pipeline on at least one hardware logic device, and wherein the data structure is resident on the computer-readable medium.

16. The computer-readable medium of claim 15 wherein the data structure comprises one selected from the group consisting of: (1) high level source code that is machine-readable by a compiler to generate code level logic, (2) high level source code that is machine-readable by a synthesizer to generate gate level logic, (3) code level logic that is machine-readable by a synthesizer to generate gate level logic, (4) gate level logic that is machine-readable by a place and route tool to generate a configuration template for loading onto a hardware logic device, and (5) a configuration template for loading onto a hardware logic device.

17. A method of providing a data structure for conversion into a configuration template for configuring a hardware logic device, the method comprising:
providing a data structure that is convertible into a configuration template for loading onto a hardware logic device, the data structure comprising logic for a seed generation stage for a BLAST pipeline, an ungapped analysis stage for a BLAST pipeline, and a gapped analysis stage for a BLAST pipeline, and
providing a tool for use in a process of converting the data structure into the configuration template.

18. A method of converting a data structure to a new data structure, the method comprising:
accessing a first data structure that is convertible into a configuration template for loading onto a hardware logic device, the first data structure comprising logic for a seed generation stage for a BLAST pipeline, an ungapped analysis stage for a BLAST pipeline, and a gapped analysis stage for a BLAST pipeline, and
using at least one tool to convert the first data structure into a second data structure, the second data structure comprising one selected from the group consisting of (1) a new data structure that is also convertible into a configuration template for loading onto a hardware logic device, and (2) a configuration template for loading onto a hardware logic device.

19. An apparatus for sequence alignment searching to find a plurality of hits between a plurality of database substrings and a plurality of query substrings, each database substring corresponding to a plurality of items of a database sequence and each query substring corresponding to a plurality of items of a query sequence, the apparatus comprising:
a hit generator, the hit generator comprising (1) a memory configured as a lookup table and (2) a table lookup unit in communication with the memory;
wherein the lookup table is configured to store a plurality of hit identifiers, each hit identifier corresponding to a hit between a database substring and a query substring;
wherein the table lookup unit is configured to (1) receive a bit stream corresponding to a plurality of database substrings, and (2) for each received database substring, access the lookup table to retrieve therefrom each hit identifier corresponding to that database substring; and
wherein at least the table lookup unit is implemented on a hardware logic device.

20. The apparatus of claim 19 wherein the hardware logic device comprises a reconfigurable logic device.

21. The apparatus of claim 20 wherein each database substring comprises a database w-mer and wherein each query substring comprises a query w-mer, the database w-mers and the query w-mers comprising residue substrings of length w, the apparatus further comprising:
a w-mer feeder unit in communication with the hit generator, the w-mer feeder unit being configured to (1) receive and process a bitstream comprising at least a portion of the database sequence to thereby generate a plurality of database w-mers for delivery to the hit generator and (2) generate a database sequence pointer for each database w-mer that identifies a position within the database sequence for each database w-mer, wherein the w-mer feeder unit is implemented on the reconfigurable logic device.

22. The apparatus of claim 21 wherein the table lookup unit is further configured to index the lookup table by a value corresponding to each database w-mer, and wherein each hit identifier comprises a pointer stored in an address of the lookup table corresponding to that database w-mer, the pointer comprising a query sequence pointer to a position of a query w-mer in the query sequence that is deemed a match to that database w-mer.

23. The apparatus of claim 22 wherein the query w-mers in the query sequence that are deemed a match to a given database w-mer comprise a neighborhood of query w-mers.

24. The apparatus of claim 23 wherein the lookup table comprises a modular delta encoding of the hit identifiers.

25. The apparatus of claim 24 wherein the lookup table comprises a primary table and a duplicate table, the primary table being configured to store up to a preselected number of hit identifiers corresponding to a given w-mer, and the duplicate table being configured to store hit identifiers corresponding to a given w-mer wherein the number of hit identifiers exceeds the pre-selected number.

26. The apparatus of claim 24 wherein the hit generator further comprises a base conversion unit in communication with the w-mer feeder unit and the table lookup unit, the base conversion unit being configured to (1) receive the stream of database w-mers from the w-mer feeder unit, and (2) change the base of each database w-mer, thereby generating a plurality of base-converted database w-mers, and wherein the bitstream received by the table lookup unit comprises a bitstream of the base-converted database w-mers.

27. The apparatus of claim 26 further comprising a hit compute unit in communication with the table lookup unit, the hit compute unit being configured to (1) receive a stream of query sequence pointers from the table lookup unit, (2) decode the modular delta-encoded query sequence pointers, (3) output a stream of hits, each hit corresponding to a query sequence pointer paired with a database sequence pointer.

28. The apparatus of claim 20 wherein the memory comprises a memory that is not implemented on the reconfigurable logic device.

29. The apparatus of claim 28 wherein the memory comprises an SRAM memory device.

30. The apparatus of claim 20 wherein the reconfigurable logic device comprises a field programmable gate array (FPGA).

31. A method for sequence alignment searching to find a plurality of hits between a plurality of database substrings and a plurality of query substrings, each database substring corresponding to a plurality of items of a database sequence and each query substring corresponding to a plurality of items of a query sequence, the method comprising:
maintaining a lookup table that stores a plurality of hit identifiers, each hit identifier corresponding to a hit between a database substring and a query substring;
receiving a bitstream comprising a plurality of database substrings;
for each received database substring, accessing the lookup table to retrieve therefrom each hit identifier corresponding to that database substring; and
wherein the receiving and accessing steps are performed by a hardware logic device.

32. The method of claim 31 wherein the hardware logic device comprises a reconfigurable logic device.

33. The method of claim 31 wherein the database sequence comprises a protein biosequence.

34. The method of claim 31 wherein the query sequence comprises a protein biosequence.

35. The method of claim 31 wherein the database sequence comprises a profile.

36. The method of claim 31 wherein the query sequence comprises a profile.

37. A computer-readable medium for sequence alignment searching to find a plurality of hits between a plurality of database substrings and a plurality of query substrings, each database substring corresponding to a plurality of items of a database sequence and each query substring corresponding to a plurality of items of a query sequence, the computer-readable medium comprising:
a data structure comprising logic for a table lookup unit for accessing a lookup table, the lookup table being configured to store a plurality of hit identifiers, each hit identifier corresponding to a hit between a database substring and a query substring, the table lookup unit being configured to (1) receive a bit stream corresponding to a plurality of database substrings, and (2) for each received database substring, access the lookup table to retrieve therefrom each hit identifier corresponding to that database substring, wherein the data structure is configured such that the table lookup unit will be implemented on a hardware logic device, and wherein the data structure is resident on the computer-readable medium.

38. The computer-readable medium of claim 37 wherein the data structure comprises one selected from the group consisting of: (1) high level source code that is machine-readable by a compiler to generate code level logic, (2) high level source code that is machine-readable by a synthesizer to generate gate level logic, (3) code level logic that is machine-readable by a synthesizer to generate gate level logic, (4) gate level logic that is machine-readable by a place and route tool to generate a configuration template for loading onto a hardware logic device, and (5) a configuration template for loading onto a hardware logic device.

39. An apparatus for sequence alignment searching to find a plurality of hits between a plurality of database substrings and a plurality of query substrings, each database substring corresponding to a plurality of items of a database sequence and each query substring corresponding to a plurality of items of a query sequence, the apparatus comprising:
a word matching module configured to (1) receive a bitstream comprising a plurality of data substrings and (2) find a plurality of hits between the data substrings and a plurality of query substrings; and
a hit filtering module in communication with the word matching module, the hit filtering module configured to (1) receive a stream of hits from the word matching module and (2) filter the received hits based at least in part upon whether a plurality of hits are determined to be sufficiently close to each other in the database sequence; and
wherein the hit filtering module is implemented on a hardware logic device.

40. The apparatus of claim 39 wherein the hardware logic device comprises a reconfigurable logic device.

41. The apparatus of claim 40 wherein at least a portion of the word matching module is implemented on the reconfigurable logic device.

42. The apparatus of claim 41, wherein the word matching module is further configured to provide a stream of hits to the hit filtering module, wherein each hit is defined as a query sequence position identifier paired with a database sequence position identifier, and wherein the hit filtering module is configured to (1) compute a diagonal index from each hit's query sequence position identifier and database sequence position identifier and (2) filter the hits at least partially on the basis of which hits share the same diagonal index.

43. The apparatus of claim 42 wherein the hit filtering module comprises a two hit module.

44. The apparatus of claim 43 wherein the two hit module is configured to maintain a hit if that hit includes a database sequence position identifier whose value is within a pre-selected distance from a value for a database sequence position identifier of a hit sharing the same diagonal index value.

45. The apparatus of claim 44 wherein the two hit module comprises a BRAM memory unit for storing each hit's database sequence position identifier value indexed by that hit's diagonal index value.

46. The apparatus of claim 42 further comprising a plurality of the hit filtering modules and a switch in communication with the word matching module and the plurality of hit filtering modules, wherein the switch is configured to selectively route each hit from the word matching module to one of the plurality of the hit filtering modules.

47. The apparatus of claim 42 wherein the switch is configured to (1) associate each hit filtering module with at least one diagonal index value, and (2) route each hit to a hit filtering module based on which hit filtering module is associated with the diagonal index value for that hit.

48. The apparatus of claim 47 wherein the switch is configured to modulo division route the hits to the hit filtering modules.

49. The apparatus of claim 48 further comprising a plurality of the word matching modules, a plurality of the switches, and a plurality of buffered multiplexers, each switch being in communication with a word matching module and each of the buffered multiplexers, each buffered multiplexer being in communication with a hit filtering module, and wherein each buffered multiplexer is configured to multiplex hits that are destined for the hit filtering module in communication therewith and that are received from the plurality of switches.

50. The apparatus of claim 49 wherein each hit maintained by the hit filtering module comprises a seed, the apparatus further comprising a seed reduction module that is configured to multiplex the seeds produced by the plurality of hit filtering modules into a single stream of seeds.

51. The apparatus of claim 46 further comprising a plurality of ungapped extension analysis circuits implemented on the hardware logic device, wherein each hit filtering module is configured to route its hits to at least one of the plurality of ungapped extension analysis circuits.

52. A method for sequence alignment searching to find a plurality of hits between a plurality of database substrings and a plurality of query substrings, each database substring corresponding to a plurality of items of a database sequence and each query substring corresponding to a plurality of items of a query sequence, the method comprising:
receiving a bitstream comprising a plurality of data substrings;
finding a plurality of hits between the data substrings and a plurality of query substrings; and
filtering the received hits based at least in part upon whether a plurality of hits are determined to be sufficiently close to each other in the database sequence; and
wherein the filtering step is performed by a hardware logic device.

53. The method of claim 52 wherein the hardware logic device comprises a reconfigurable logic device.

54. The method of claim 52 wherein the database sequence comprises a protein biosequence.

55. The method of claim 52 wherein the query sequence comprises a protein biosequence.

56. The method of claim 52 wherein the database sequence comprises a profile.

57. The method of claim 52 wherein the query sequence comprises a profile.

58. A computer-readable medium for sequence alignment searching to find a plurality of hits between a plurality of database substrings and a plurality of query substrings, each database substring corresponding to a plurality of items of a database sequence and each query substring corresponding to a plurality of items of a query sequence, the computer-readable medium comprising:
a data structure comprising (1) first logic for a word matching module configured to (a) receive a bitstream comprising a plurality of data substrings and (b) find a plurality of hits between the data substrings and a plurality of query substrings, and (2) second logic for a hit filtering module in communication with the word matching module, the hit filtering module configured to (a) receive a stream of hits from the word matching module and (b) filter the received hits based at least in part upon whether a plurality of hits are determined to be sufficiently close to each other in the database sequence, wherein the data structure is configured such that the word matching module and the hit filtering module will be implemented on a hardware logic device as a data processing pipeline, and wherein the data structure is resident on the computer-readable medium.

59. The computer-readable medium of claim 58 wherein the data structure comprises one selected from the group consisting of: (1) high level source code that is machine-readable by a compiler to generate code level logic, (2) high level source code that is machine-readable by a synthesizer to generate gate level logic, (3) code level logic that is machine-readable by a synthesizer to generate gate level logic, (4) gate level logic that is machine-readable by a place and route tool to generate a configuration template for loading onto a hardware logic device, and (5) a configuration template for loading onto a hardware logic device.

60. A method for populating a lookup table for use in finding hits between a plurality of database substrings and a plurality of query substrings, each database substring corresponding to a plurality of items of a database sequence and each query substring corresponding to a plurality of items of a query sequence, the method comprising:
for each of a plurality of query substrings, determining each position in the query sequence therefor;
modular delta encoding the determined positions; and
storing the modular delta encoded positions in a lookup table that is addressed at least partially by a plurality of item substrings corresponding to all possible combinations of items having a length equal to the query substrings.

61. The method of claim 60 wherein the lookup table comprises a primary table and a duplicate table, wherein the storing step comprises:
for each query substring having a number of modular delta encoded positions that is less than or equal to a pre-selected value, storing those modular delta encoded positions in the primary table at an address corresponding to that query substring; and
for each query substring having a number of modular delta encoded positions that exceeds the pre-selected value, (1) storing those modular delta encoded positions in the duplicate table and (2) storing, at an address in the primary table corresponding to that query substring, data that identifies where in the duplicate table that those modular delta encoded positions can be found.

62. The method of claim 61 further comprising using a bit stored in each address of the primary table as a bit signifying whether the modular delta encoded positions for the query substring for that address are found in the primary table or the duplicate table.

63. The method of claim 61 further comprising:
for each query substring, determining a plurality of query substrings that are within a neighborhood of that query substring; and
wherein the positions determined by the position determining step also include the positions of the query substrings that were determined to be in the neighborhood of that query substring.

64. The method of claim 60 further comprising:
base converting the query substrings prior to the modular delta encoding step to reduce the amount of memory required for the lookup table.

65. The method of claim 60 further comprising:
performing the determining, encoding and storing steps for at least one query sequence prior to performing a similarity search between the database sequence and the at least one query sequence using a hardware logic device that is configured to access the lookup table as parts of the similarity search.

66. The method of claim 60 wherein the database sequence comprises a protein biosequence.

67. The method of claim 60 wherein the query sequence comprises a protein biosequence.

68. A computer readable medium for populating a lookup table for use in finding hits between a plurality of database substrings and a plurality of query substrings, each database substring corresponding to a plurality of items of a database sequence and each query substring corresponding to a plurality of items of a query sequence, the computer readable medium comprising:
a code segment executable by a processor for, for each of a plurality of query substrings, determining each position in the query sequence therefor;
a code segment executable by a processor for modular delta encoding the determined positions; and
a code segment executable by a processor for storing the modular delta encoded positions in a lookup table that is addressed at least partially by a plurality of item substrings corresponding to all possible combinations of items having a length equal to the query substrings.

69. An apparatus for sequence alignment searching for finding pairs of interest corresponding to a plurality of hits between a plurality of database substrings and a plurality of query substrings, each database substring corresponding to a plurality of items of a database sequence and each query substring corresponding to a plurality of items of a query sequence, the apparatus comprising:
a module for ungapped extension analysis, the module being configured to (1) receive a stream of hits between a plurality of database substrings and a plurality of query substrings, and (2) identify which hits are high scoring pairs (HSPs) on the basis of a scoring matrix; and
wherein the ungapped extension analysis module is implemented on at least one hardware logic device.

70. The apparatus of claim 69 wherein the at least one hardware logic device comprises at least one reconfigurable logic device.

71. The apparatus of claim 70 wherein the ungapped extension analysis module comprises a BLASTP ungapped extension analysis module.

72. The apparatus of claim 71 wherein the scoring matrix comprises a BLOSUM-62 scoring matrix.

73. The apparatus of claim 72 wherein the scoring matrix is stored in at least one BRAM unit that is implemented on the at least one reconfigurable logic device.

74. The apparatus of claim 70 wherein the at least one reconfigurable logic device comprises at least one field programmable gate array (FPGA).

75. A method for sequence alignment searching to find pairs of interest corresponding to a plurality of hits between a plurality of database substrings and a plurality of query substrings, each database substring corresponding to a plurality of items of a database sequence and each query substring corresponding to a plurality of items of a query sequence, the method comprising:
receiving a stream of hits between a plurality of database substrings and a plurality of query substrings;
performing an ungapped extension analysis on the received hits using a scoring matrix to identify which hits are high scoring pairs (HSPs); and
wherein the receiving step and the performing step are performed by at least one hardware logic device.

76. The method of claim 75 wherein the at least one hardware logic device comprises at least one reconfigurable logic device.

77. The method of claim 75 wherein the database sequence comprises a protein biosequence.

78. The method of claim 75 wherein the query sequence comprises a protein biosequence.

79. The method of claim 75 wherein the database sequence comprises a profile.

80. The method of claim 75 wherein the query sequence comprises a profile.

81. A computer-readable medium for sequence alignment searching for finding pairs of interest corresponding to a plurality of hits between a plurality of database substrings and a plurality of query substrings, each database substring corresponding to a plurality of items of a database sequence and each query substring corresponding to a plurality of items of a query sequence, the computer-readable medium comprising:
a data structure comprising logic for a module for ungapped extension analysis, the module being configured to (1) receive a stream of hits between a plurality of database substrings and a plurality of query substrings, and (2) identify which hits are high scoring pairs (HSPs) on the basis of a scoring matrix, wherein the data structure is configured such that the ungapped extension analysis module will be implemented on a hardware logic device, and wherein the data structure is resident on the computer-readable medium.

82. The computer-readable medium of claim 81 wherein the data structure comprises one selected from the group consisting of: (1) high level source code that is machine-readable by a compiler to generate code level logic, (2) high level source code that is machine-readable by a synthesizer to generate gate level logic, (3) code level logic that is machine-readable by a synthesizer to generate gate level logic, (4) gate level logic that is machine-readable by a place and route tool to generate a configuration template for loading onto a hardware logic device, and (5) a configuration template for loading onto a hardware logic device.

83. An apparatus for sequence alignment searching using hits between a plurality of database substrings and a plurality of query substrings, each database substring corresponding to a plurality of items of a database sequence and each query substring corresponding to a plurality of items of a query sequence, the apparatus comprising:
a module for gapped extension analysis, the module being configured to (1) receive a stream of hits between a plurality of database substrings and a plurality of query substrings, and (2) identify the hits in the hit stream for which there exists an alignment of interest that exceeds a threshold using a banded Smith-Waterman algorithm;
wherein the gapped extension analysis module is implemented on at least one hardware logic device.

84. The apparatus of claim 83 wherein the at least one hardware logic device comprises at least one reconfigurable logic device.

85. The apparatus of claim 84 wherein the gapped extension analysis module comprises a BLASTP gapped extension analysis module.

86. The apparatus of claim 84 wherein the banded Smith-Waterman algorithm comprises a seeded and banded Smith-Waterman algorithm.

87. The apparatus of claim 84 wherein the at least one reconfigurable logic device comprises at least one field programmable gate array.

88. A method for sequence alignment searching using hits between a plurality of database substrings and a plurality of query substrings, each database substring corresponding to a plurality of items of a database sequence and each query substring corresponding to a plurality of items of a query sequence, the method comprising:
receiving a stream of hits between a plurality of database substrings and a plurality of query substrings; and
performing a banded Smith-Waterman gapped extension analysis on the received hits to identify whether any hits will produce an alignment that exceeds a threshold within a band geometry; and
wherein the receiving step and the performing step are performed by at least one hardware logic device.

89. The method of claim 88 wherein the at least one hardware logic device comprises at least one reconfigurable logic device.

90. A computer-readable medium for sequence alignment searching using hits between a plurality of database substrings and a plurality of query substrings, each database substring corresponding to a plurality of items of a database sequence and each query substring corresponding to a plurality of items of a query sequence, the computer-readable medium comprising:
a data structure comprising logic for a module for gapped extension analysis, the module being configured to (1) receive a stream of hits between a plurality of database substrings and a plurality of query substrings, and (2) identify the hits in the hit stream for which there exists an alignment of interest that exceeds a threshold using at least one selected from the group consisting of a banded Smith-Waterman algorithm and a seeded Smith-Waterman algorithm, wherein the data structure is configured such that the gapped extension analysis module will be implemented on a hardware logic device, and wherein the data structure is resident on the computer-readable medium.

91. The computer-readable medium of claim 90 wherein the data structure comprises one selected from the group consisting of: (1) high level source code that is machine-readable by a compiler to generate code level logic, (2) high level source code that is machine-readable by a synthesizer to generate gate level logic, (3) code level logic that is machine-readable by a synthesizer to generate gate level logic, (4) gate level logic that is machine-readable by a place and route tool to generate a configuration template for loading onto a hardware logic device, and (5) a configuration template for loading onto a hardware logic device.

92. An apparatus for sequence alignment searching using hits between a plurality of database substrings and a plurality of query substrings, each database substring corresponding to a plurality of items of a database sequence and each query substring corresponding to a plurality of items of a query sequence, the apparatus comprising:
a module for gapped extension analysis, the module being configured to (1) receive a stream of hits between a plurality of database substrings and a plurality of query substrings, and (2) identify hits within the hit stream for which there exists an alignment that exceeds a threshold using a seeded Smith-Waterman algorithm;
wherein the gapped extension analysis module is implemented on at least one hardware logic device.

93. The apparatus of claim 92 wherein the at least one hardware logic device comprises at least one reconfigurable logic device.

94. A method for sequence alignment searching using hits between a plurality of database substrings and a plurality of query substrings, each database substring corresponding to a plurality of items of a database sequence and each query substring corresponding to a plurality of items of a query sequence, the method comprising:
receiving a stream of hits between a plurality of database substrings and a plurality of query substrings; and
performing a gapped extension analysis on the received hits using a seeded Smith-Waterman algorithm to identify whether any hits correspond to an alignment of interest; and
wherein the receiving step and the performing step are performed by at least one hardware logic device.

95. The method of claim 94 wherein the at least one hardware logic device comprises at least one reconfigurable logic device.

96. A computer-implemented method comprising:
storing a first template that defines a first sequence analysis algorithm;
storing a second template that defines a second sequence analysis algorithm;
selecting one of the stored templates; and
loading the selected template onto a reconfigurable logic device to thereby configure that reconfigurable logic device to perform a sequence analysis corresponding to the loaded template when a database sequence is streamed through the reconfigurable logic device.

97. The method of claim 96 wherein the first sequence analysis algorithm comprises a BLASTP similarity searching operation and wherein the second sequence analysis algorithm comprises a BLASTN similarity searching operation.

98. A computer-implemented method comprising:
selecting whether a first sequence analysis algorithm or a second sequence analysis algorithm is to be performed;
defining a template for the selected one of the first and second sequence analysis algorithms; and
loading the defined template onto a reconfigurable logic device to thereby configure that reconfigurable logic device to perform a sequence analysis corresponding to the loaded template when a database sequence is streamed through the reconfigurable logic device.

99. The method of claim 98 wherein the first sequence analysis algorithm comprises a BLASTN similarity search and wherein the second sequence analysis algorithm comprises a BLASTP similarity search.
